(19) United States
(12) Patent Application Publication
(10) Pub. No.: US 2022/0291342 A1
(43) Pub. Date: Sep. 15, 2022

(54) RANGING SYSTEM AND DRIVER OF LIGHT EMITTING ELEMENT

(71) Applicant: Sony Semiconductor Solutions Corporation, Kanagawa (JP)

(72) Inventors: Daisuke Suzuki, Tokyo (JP); Takashi Masuda, Tokyo (JP); Mitsushi Tabata, Kanagawa (JP); Kouta Hiyama, Kanagawa (JP); Koichi Okamoto, Kanagawa (JP); Akihiko Miyanohara, Tokyo (JP)

(21) Appl. No.: 17/636,968

(22) PCT Filed: Aug. 27, 2020
(86) PCT No.: PCT/JP2020/032471

§ 371 Date: Feb. 21, 2022

Related U.S. Application Data
(60) Provisional application No. 62/893,041, filed on Aug. 28, 2019.
(60) Provisional application No. 62/893,405, filed on Aug. 29, 2019.

(51) Int. Cl. G01S 7/484; G01S 7/4865; G01S 7/497; G01S 17/14

(52) U.S. Cl. CPC G01S 7/484; G01S 7/4865; G01S 7/497; G01S 17/14

(57) ABSTRACT

Proposed is a ranging system capable of improving the accuracy of ranging. A ranging system (70) includes: a drive unit (24) that causes a light emitting element to emit light and outputs a drive signal for irradiating a target with light; a sensor unit (302) that detects reflected light from the target; a measurement unit (23) that measures a delay time that is included in a time from timing at which a trigger signal for causing the light emitting element to emit light is output to timing at which the light emitting element actually emits light; and a ranging observation unit (52) which is a processing unit that performs a process of calculating a distance to the target on the basis of output timing of the trigger signal, light receiving timing of the reflected light obtained by the sensor unit, and the delay time.

### FIELD

The present invention relates to a ranging system and a driver of a light emitting element.

### BACKGROUND

Ranging systems that measure a distance to an object by irradiating the object with light and detecting the reflected light are known. For example, in Patent Literature 1, an object is irradiated with light from a light emitting unit, the reflected light from the object is received by a light receiving sensor, and a distance to the object is measured on the basis of time of flight (TOF).

### CITATION LIST

### Patent Literature

Patent Literature 1: JP 2016-211881 A

### SUMMARY

### Technical Problem

However, the technology described in Patent Literature 1 has room for improvement in improving the accuracy of ranging.

Therefore, the present disclosure proposes a ranging system and a driver of a light emitting element capable of improving the accuracy of ranging.

### Solution to Problem

A ranging system according to the present disclosure includes: a drive unit that causes a light emitting element to emit light and outputs a drive signal for irradiating a target with light; a sensor unit that detects reflected light from the target; a measurement unit that measures a delay time that is included in a time from timing at which a trigger signal for causing the light emitting element to emit light is output to timing at which the light emitting element actually emits light; and a processing unit that performs a process of calculating a distance to the target on a basis of output timing of the trigger signal, light receiving timing of the reflected light obtained by the sensor unit, and the delay time.

A driver of a light emitting element according to the present disclosure includes: a drive unit that causes the light emitting element to emit light and outputs a drive signal for irradiating a target with light; and a measurement unit that measures a delay time that is included in a time from timing at which a trigger signal for causing the light emitting element to emit light is input to timing at which the light emitting element actually emits light, wherein the driver outputs data corresponding to the delay time measured by the measurement unit.

### BRIEF DESCRIPTION OF DRAWINGS

FIG. 1 is a block diagram illustrating a configuration of an example of a ranging system applicable to each embodiment of the present disclosure.

FIG. 2 is a diagram illustrating an example of a histogram based on time when a ranging sensor unit receives light that is applicable to a ranging system.

FIG. 3 is a diagram illustrating an example of another ranging system of the present disclosure.

FIG. 4 is a diagram illustrating a configuration of the main part of a ranging system of a comparative example.

FIG. 5 is a diagram illustrating an operation example of the ranging system of the comparative example.

FIG. 6 is a diagram illustrating a ranging system according to a first embodiment of the present disclosure.

FIG. 7 is a timing chart illustrating an operation example of the ranging system according to the first embodiment.

FIG. 8 is a flowchart illustrating a first operation example of the ranging system according to the first embodiment.

FIG. 9 is a flowchart illustrating a second operation example of the ranging system according to the first embodiment.

FIG. 10 is a diagram illustrating a ranging system according to a first modification of the first embodiment.

FIG. 11 is a diagram illustrating a ranging system according to a second modification of the first embodiment.

FIG. 12 is a diagram illustrating a ranging system according to a third modification of the first embodiment.

FIG. 13 is a diagram illustrating a ranging system according to a fourth modification of the first embodiment.

FIG. 14 is a diagram illustrating a ranging system according to a fifth modification of the first embodiment.

FIG. 15 is a timing chart illustrating an operation example of a ranging system according to a fifth modification of the first embodiment.

FIG. 16 is a diagram illustrating a ranging system according to a sixth modification of the first embodiment.

FIG. 17 is a diagram illustrating a ranging system according to a seventh modification of the first embodiment.

FIG. 18 is a diagram illustrating a ranging system according to an eighth modification of the first embodiment.

FIG. 19A is a diagram illustrating a ranging system according to a ninth modification of the first embodiment.

FIG. 19B is a diagram illustrating a ranging system according to the ninth modification of the first embodiment.

FIG. 19C is a diagram illustrating a ranging system according to the ninth modification of the first embodiment.

FIG. 20 is a diagram illustrating a ranging system according to a tenth modification of the first embodiment.

FIG. 21 is a diagram illustrating a ranging system according to an eleventh modification of the first embodiment.

FIG. 22 is a diagram illustrating a ranging system according to a second embodiment of the present disclosure.

FIG. 23 is a flowchart illustrating an operation example of the ranging system according to the second embodiment of the present disclosure.

FIG. 24 is a diagram for explaining an exemplary calculation of delay time by the ranging system according to the second embodiment.

FIG. 25 is a diagram illustrating an example of rise timing of the main signals of the ranging system according to the second embodiment.

FIG. 26 is a diagram illustrating a ranging system according to a first modification of the second embodiment.

FIG. 27 is a diagram illustrating a ranging system according to a second modification of the second embodiment.

FIG. 28 is a diagram illustrating a ranging system according to a third modification of the second embodiment.

FIG. 29 is a diagram illustrating a ranging system according to a fourth modification of the second embodiment.

FIG. 30A is a diagram illustrating a ranging system according to a fifth modification of the second embodiment.

FIG. 30B is a diagram illustrating a ranging system according to the fifth modification of the second embodiment.

FIG. 31 is a diagram illustrating an example of a dummy load.

FIG. 32A is a diagram illustrating a ranging system according to a sixth modification of the second embodiment.

FIG. 32B is a diagram illustrating a ranging system according to the sixth modification of the second embodiment.

FIG. 33 is a diagram illustrating a ranging system according to a seventh modification of the second embodiment.

FIG. 34 is a diagram illustrating a ranging system according to an eighth modification of the second embodiment.

FIG. 35 is a diagram illustrating a ranging system according to a ninth modification of the second embodiment.

FIG. 36 is a diagram illustrating a ranging system according to a tenth modification of the second embodiment.

FIG. 37 is a diagram illustrating an example in which a plurality of laser diodes is two-dimensionally arrayed.

FIG. 38 is a diagram illustrating a ranging system according to an eleventh modification of the second embodiment.

FIG. 39 is a diagram for explaining the operation of a light emission waveform generating circuit.

FIG. 40A is a diagram illustrating a ranging system according to a third embodiment.

FIG. 40B is a diagram illustrating a ranging system according to the third embodiment.

FIG. 40C is a diagram illustrating a ranging system according to the third embodiment.

FIG. 41 is a diagram illustrating a ranging system according to a fourth embodiment.

### DESCRIPTION OF EMBODIMENTS

Hereinafter, embodiments of the present disclosure will be described in detail on the basis of the drawings. Note that in each of the following embodiments, the same parts are denoted by the same symbols, and redundant description will be omitted.

In addition, the present disclosure will be described in the following order of items.

0. Configuration Shared by Embodiments

0.1 Comparative Example
0.2 Configuration
0.3 Operation

1. First Embodiment
1.1 Configuration
1.2 Operation
1.2.1 First Operation Example
1.2.2 Second Operation Example
1.3 Effects

1.4 First Modification of First Embodiment
1.4.1 Configuration
1.4.2 Operation
1.4.3 Effects

1.5 Second Modification of First Embodiment
1.5.1 Configuration
1.5.2 Operation
1.5.3 Effects

1.6 Third Modification of First Embodiment
1.6.1 Configuration
1.6.2 Operation
1.6.3 Effects

1.7 Fourth Modification of First Embodiment
1.7.1 Configuration
1.7.2 Operation

11.7.3 Effects

1.8 Fifth Modification of First Embodiment
1.8.1 Configuration
1.8.2 Operation
1.8.2.1 Operation Example
1.8.3 Effects

1.9 Sixth Modification of First Embodiment
1.9.1 Configuration
1.9.2 Operation
1.9.3 Effects

1.10 Seventh Modification of First Embodiment
1.10.1 Configuration
1.10.2 Operation
1.10.3 Effects

1.11 Eighth Modification of First Embodiment
1.11.1 Configuration
1.11.2 Operation
1.11.3 Effects

1.12 Ninth Modification of First Embodiment
1.12.1 Configuration
1.12.2 Operation
1.12.3 Effects

1.13 Tenth Modification of First Embodiment
1.13.1 Configuration
1.13.2 Operation
1.13.3 Effects

1.14 Eleventh Modification of First Embodiment
1.14.1 Configuration
1.14.2 Operation
1.14.3 Effects

2. Second Embodiment
2.1 Configuration
2.2 Operation
2.3 Effects

2.4 First Modification of Second Embodiment
2.4.1 Configuration
2.4.2 Operation
2.4.3 Effects

2.5 Second Modification of Second Embodiment
2.5.1 Configuration
2.5.2 Operation
2.5.3 Effects

2.6 Third Modification of Second Embodiment
2.6.1 Configuration
2.6.2 Operation
2.6.3 Effects

2.7 Fourth Modification of Second Embodiment
2.7.1 Configuration
2.7.2 Operation
2.7.3 Effects

2.8 Fifth Modification of Second Embodiment
2.8.1 Configuration
2.8.2 Operation
2.8.3 Effects

2.9 Sixth Modification of Second Embodiment
2.9.1 Configuration
2.9.2 Operation
2.9.3 Effects

2.10 Seventh Modification of Second Embodiment
2.10.1 Configuration
2.10.2 Operation
2.10.3 Effects

2.11 Eighth Modification of Second Embodiment
2.11.1 Configuration
2.11.2 Operation
2.11.3 Effects

2.12 Ninth Modification of Second Embodiment
2.12.1 Configuration
2.12.2 Operation
2.12.3 Effects

2.13 Tenth Modification of Second Embodiment
2.13.1 Configuration
2.13.2 Operation
2.13.3 Effects

2.14 Eleventh Modification of Second Embodiment
2.14.1 Configuration
2.14.2 Operation
2.14.3 Effects

3. Third Embodiment

4. Fourth Embodiment

5. Summary

### 0. Configuration Shared by Embodiments

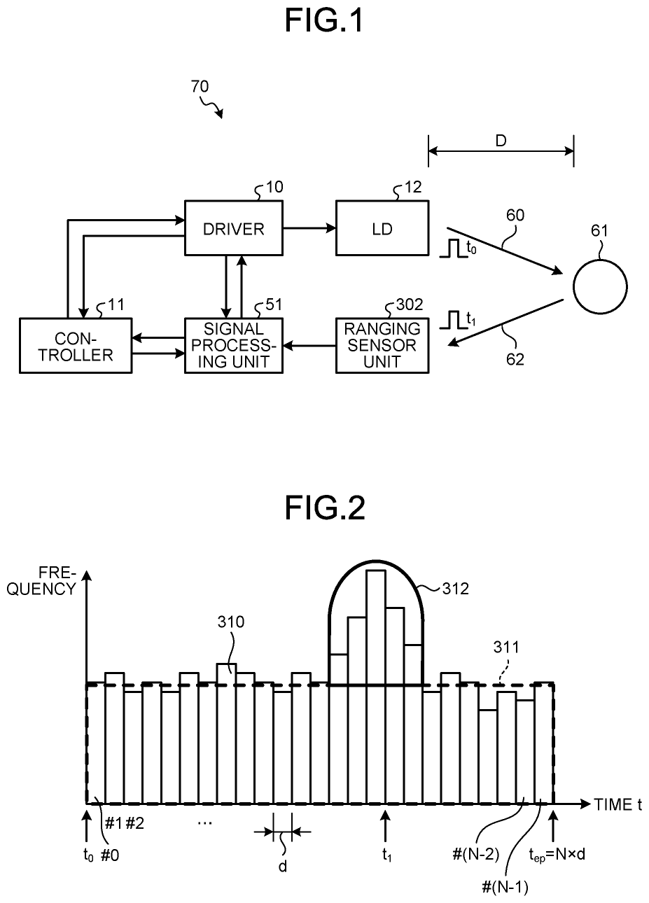

The present disclosure relates to control of a light emitting element that emits light in response to a current, such as a laser diode. FIG. 1 is a block diagram illustrating a configuration of an example of a ranging system 70 applicable to each embodiment of the present disclosure. Note that, in the following description, it is presumed that the light emitting element is a laser diode (LD). Laser diodes are used in various fields such as ranging, optical transmission, and electrophotographic printers by leveraging characteristics such as excellent light straightness and light condensing property, high response speed, and low power consumption. Note that a light emitting element applicable to the present disclosure is not limited to the laser diodes. For example, a light emitting diode (LED) can also be applied as the light emitting element.

In FIG. 1, the ranging system 70 as an electronic device includes a driver 10, a laser diode 12, a controller 11, a signal processing unit 51, and a ranging sensor unit 302.

The driver 10 drives the laser diode 12 in accordance with a signal from the signal processing unit 51 to cause the laser diode 12 to emit light. The controller 11 includes, for example, a central processing unit (CPU) and a memory and supplies, to the driver 10, a control signal 40 generated by the CPU in accordance with a program prestored in a memory to control the driver 10.

The driver 10 generates a drive signal for driving the laser diode 12 to emit light in a pulse shape in accordance with the signal supplied from the signal processing unit 51. This drive signal is input to the laser diode 12. The laser diode 12 emits light by the drive signal. That is, the laser diode 12 is caused to emit light on the basis of the drive signal generated by the controller 11. The driver 10 sends, to the signal processing unit 51, a signal indicating timing at which the laser diode 12 is caused to emit light.

The controller 11 can determine whether or not an error is occurring on the basis of a detection signal 42 supplied from the driver 10. For example, in a case where delay time that is measured exceeds a determination reference value, it can be determined that an error has occurred. When it is determined that an error has occurred, the controller 11 can output an error signal. The controller 11 can output an error signal to the outside of the ranging system 70, for example.

The ranging sensor unit 302 functions as a sensor unit that detects reflected light from a target. The ranging sensor unit 302 includes a light receiving element that outputs a light receiving signal by photoelectric conversion based on laser light that is received. As the light receiving element, for example, a single photon avalanche diode is applicable. The single photon avalanche diodes are also called SPADs and have a characteristic that electrons generated in response to incidence of one photon cause avalanche multiplication, thereby allowing a large current to flow. By using this characteristic of the SPADs, incidence of one photon can be detected with high sensitivity. A light receiving element applicable to the ranging sensor unit 302 is not limited to the SPADs, and an avalanche photodiode (APD) or a normal photodiode can also be applied.

The signal processing unit 51 calculates a distance D to a target 61, as a measurement target, on the basis of time t₀ when laser light is emitted from the laser diode 12 and time t₁ when the light is received by the ranging sensor unit 302.

In the above-described configuration, laser light 60 emitted from the laser diode 12 at timing of, for example, time t₀ is reflected by the target 61, for example, and is received by the ranging sensor unit 302 at timing of time t₁ as reflected light 62. The signal processing unit 51 obtains the distance D to the target 61 on the basis of the difference between time t₁ at which the reflected light 62 is received by the ranging sensor unit 302 and time t₀ at which the laser light has been emitted by the laser diode 12. The distance D is calculated by the following Equation (1) with a constant c as the speed of light (2.9979×10⁸ [m/sec]).

D=(c/2)×(t₁−t₀) (1)

The signal processing unit 51 repeatedly executes the above process a plurality of times. The ranging sensor unit 302 may include a plurality of light receiving elements, and the distance D may be calculated on the basis of each light receiving timing at which the reflected light 62 is received by the respective light receiving elements. The signal processing unit 51 classifies time tₘ (referred to as light receiving time tₘ) from time t₀ of the light emitting timing to the light receiving timing at which the light is received by the ranging sensor unit 302 on the basis of classes (bins) and generates a histogram.

Note that light received by the ranging sensor unit 302 at the light receiving time tₘ is not limited to the reflected light 62 which is the light emitted by the laser diode 12 and reflected by the target. For example, the ambient light around the ranging sensor unit 302 is also received by the ranging sensor unit 302.

FIG. 2 is a diagram illustrating an example of a histogram, which is applicable to the ranging system 70, based on time when the ranging sensor unit 302 receives light. In FIG. 2, the horizontal axis represents the bins, and the vertical axis represents the frequency for every bin. The bins are obtained by classifying the light receiving time tₘ for every predetermined unit time d. Specifically, bin #0 is 0≤tₘ<d, bin #1 is d≤tₘ<2×d, bin #2 is 2×d≤tₘ<3×d, . . . , and bin #(N−2) is (N−2)×d≤tₘ<(N−1)×d. In a case where the exposure time of the ranging sensor unit 302 is time tₑₚ, tₑₚ=N×d. Note that N is a natural number.

The signal processing unit 51 counts the number of times of acquiring the light receiving time tₘ on the basis of the bins, obtains the frequency 310 for every bin, and generates a histogram. Here, the ranging sensor unit 302 also receives light other than the reflected light which is the light emitted from the laser diode 12 and reflected. Examples of such light other than the reflected light as a target include the ambient light. The portion indicated by an area 311 in the histogram includes ambient light components attributable to the ambient light. The ambient light is light randomly incident on the ranging sensor unit 302 and is noise with respect to the reflected light which is the target.

On the other hand, the reflected light as a target is light received depending on a specific distance and appears in the histogram as an active light component 312. A bin that corresponds to the frequency of a peak in the active light component 312 corresponds to the distance D to the target 61. The signal processing unit 51 can calculate the distance D to the target 61 in accordance with the above Equation (1) by acquiring representative time of the bin (for example, time at the center of the bin) as the above time t₁. In this manner, by using the plurality of light reception results, it is possible to execute appropriate ranging for random noise.

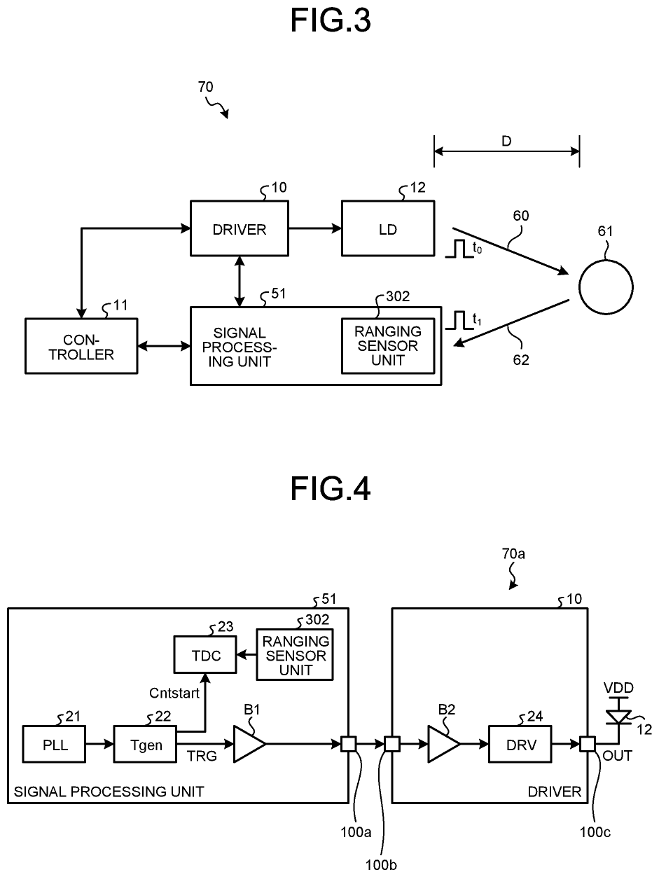

Here, FIG. 3 is a diagram illustrating an example of another ranging system 70′ of the present disclosure. In the ranging system 70′ illustrated in FIG. 3, a ranging sensor unit 302 is provided inside the signal processing unit 51 of the ranging system 70 illustrated in FIG. 1. That is, the signal processing unit 51 and the ranging sensor unit 302 are integrated. Hereinafter, a case in which the signal processing unit 51 and the ranging sensor unit 302 are integrated will be described.

(0.1 Comparative Example)

In order to facilitate understanding of the embodiments of the present disclosure, a comparative example will be described first.

[0.2 Configuration]

FIG. 4 is a diagram illustrating a configuration of the main part of a ranging system of a comparative example. In FIG. 4, a ranging system 70a of the comparative example includes a signal processing unit 51, a driver 10, and a laser diode 12. The signal processing unit 51 and the driver 10 are coupled by coupling units 100a and 100b. The driver 10 and the laser diode 12 are coupled by a coupling unit 100c.

The signal processing unit 51 includes a phase locked loop (PLL) unit 21, a light emission waveform generating circuit (Tgen) 22 as a light emission waveform generating unit, a time digital converter (TDC) 23, a buffer B1, and a ranging sensor unit 302. The PLL unit 21 outputs a clock signal serving as a reference of the operation of the ranging system 70a. The PLL unit 21 includes, for example, a voltage-controlled oscillator that outputs a clock signal and controls an oscillation frequency of the clock signal on the basis of a phase difference between the clock signal that is output and a reference signal serving as a reference. The light emission waveform generating circuit 22 receives a trigger signal TRG′ as the input. The light emission waveform generating circuit 22 generates a light emission pattern signal for causing the laser diode 12 to emit light. The light emission waveform generating circuit 22 outputs a count start signal Cntstart simultaneously with the light emission pattern signal.

The TDC 23 outputs a digital signal corresponding to a time period starting from the timing at which the trigger signal TRG is input to the timing at which the ranging sensor unit 302 detects reflected light. The TDC 23 includes a counter for counting time, and counts time from the timing when the count start signal Cntstart is input to the timing when the ranging sensor unit 302 receives the reflected light.

The buffer B1 includes, for example, two complementary metal oxide semiconductor (CMOS) inverters connected in cascade. Alternatively, a differential buffer conforming to the low voltage differential signaling (LVDS) standards may be used. This similarly applies to buffers in the following description.

The driver 10 includes a buffer B2 and a drive unit (DRV) 24. The buffer B2 includes, for example, two CMOS inverters connected in cascade. The drive unit 24 outputs a drive signal for causing the laser diode 12 to emit light. More specifically, the drive unit 24 generates a drive current for causing the laser diode 12 to emit light and supplies the drive current that has been generated to the laser diode 12 as an output signal OUT.

An anode terminal of the laser diode 12 is connected to a power supply voltage V_{DD}. A cathode terminal of the laser diode 12 is connected to the coupling unit 100c. Note that the anode terminal of the laser diode 12 may be connected to the coupling unit 100c, and the cathode terminal of the laser diode 12 may be connected to the ground. In this case, the drive current flows from the drive unit 24 to the laser diode 12 via the coupling unit 100c.

[0.3 Operation]

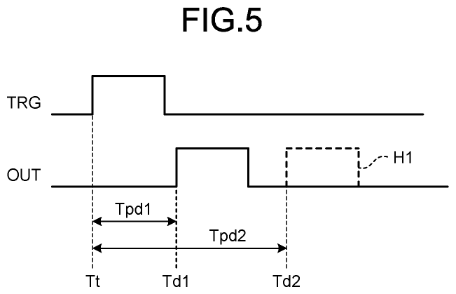

FIG. 5 is a diagram illustrating an operation example of the ranging system 70a of the comparative example illustrated in FIG. 4. FIG. 5 is a diagram illustrating the trigger signal TRG and the output signal OUT. As illustrated in FIG. 5, the timing at which the trigger signal TRG rises does not coincide with the timing at which the output signal OUT rises. This is because a signal propagation delay occurs in the driver 10. For example, a time period starting from time Tt at which the trigger signal TRG rises to time Td1 at which the output signal OUT rises is defined as time Tpd1. That is, the delay time of the output signal OUT with respect to the trigger signal TRG is time Tpd1.

The delay time Tpd1 is not constant due to fluctuations in the power supply and the temperature environment and variations among individual drivers 10. For example, as indicated by a broken line H1 in FIG. 5, in a case where the time at which the output signal OUT rises is delayed from time Td1 and the output signal OUT rises at time Td2, the delay time of the output signal OUT with respect to the trigger signal TRG is time Tpd2. That is, in the present example, with respect to the trigger signal TRG, the delay time in a case where the output signal OUT rises fastest is time Tpd1, and the delay time in a case where the output signal OUT rises slowest is time Tpd2.

In the ranging system 70a, adjustment is necessary to match desired light emitting timing with the actual light emitting timing, and there is a possibility that the ranging accuracy decreases due to a propagation delay that fluctuates due to a change in the power supply and the temperature environment. In addition, a propagation delay within the signal processing unit 51 and a propagation delay in a substrate may also fluctuate, which results in a possibility that the ranging accuracy decreases. Therefore, it is necessary to improve the ranging accuracy in consideration of the fluctuation in the propagation delay time due to the power supply and the temperature environment and variations among individual drivers 10.

### 1. First Embodiment

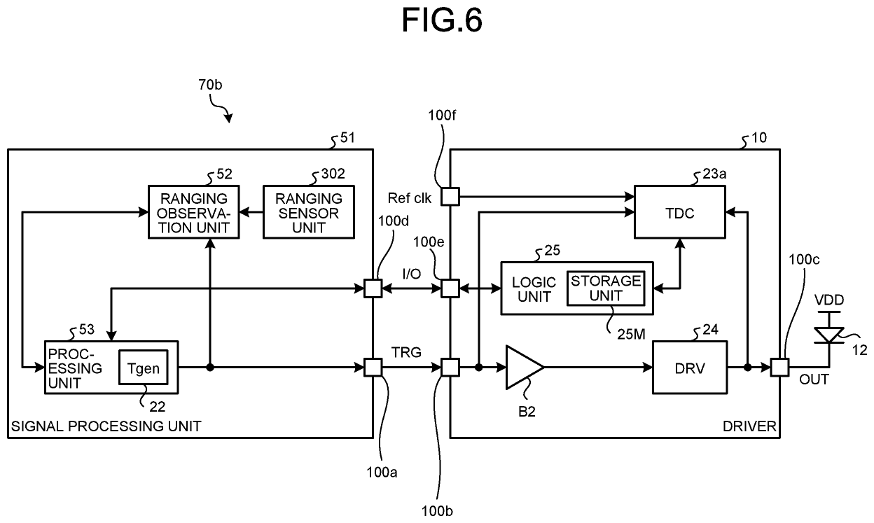

Next, a first embodiment of the present disclosure will be described. FIG. 6 is a diagram illustrating a ranging system 70b according to the first embodiment of the present disclosure.

[1.1 Configuration]

In FIG. 6, the ranging system 70b includes a signal processing unit 51, a driver 10, and a laser diode 12. The driver 10 and the signal processing unit 51 may be integrally manufactured or may be electrically connected to each other after having been separately manufactured. The above similarly applies to the following embodiments. In this example, the signal processing unit 51 and the driver 10 are coupled by coupling units 100a and 100b and coupling units 100d and 100e.

The signal processing unit 51 includes a ranging observation unit 52, a processing unit 53, and a ranging sensor unit 302. The processing unit 53 includes a light emission waveform generating circuit 22. The light emission waveform generating circuit 22, which is a light emission waveform generating unit, outputs a trigger signal TRG. The ranging observation unit 52 calculates a distance D to a target 61 on the basis of output timing of the trigger signal TRG and light receiving timing of the reflected light obtained by the ranging sensor unit 302. The processing unit 53 controls each unit of the signal processing unit 51. Since the ranging sensor unit 302 has already been described with reference to FIG. 1, detailed description thereof will be omitted here.

The driver 10 includes a buffer B2, a TDC 23a, a drive unit 24, a logic unit 25, and a coupling unit 100f. The TDC 23a starts counting time by a trigger signal TRG and ends counting time when the drive unit 24 outputs an output signal OUT. The TDC 23a outputs digital data corresponding to a delay time which is a measurement result of counting time.

The logic unit 25 includes a storage unit 25M. The storage unit 25M stores digital data corresponding to a delay time which is a measurement result by the TDC 23a. The storage unit 25M includes, for example, a register. The storage unit 25M may be a memory. A clock signal Refclk serving as a reference of the operation of the TDC 23a is input to the coupling unit 100f.

In this embodiment, the processing unit 53 of the signal processing unit 51 is connected with the logic unit 25 of the driver 10 via the coupling units 100d and 100e. The processing unit 53 and the logic unit 25 can transmit and receive input/output signals I/O. Therefore, the processing unit 53 of the signal processing unit 51 can access the storage unit 25M of the logic unit 25. Therefore, the processing unit 53 can acquire the digital data corresponding to the delay time stored in the storage unit 25M of the logic unit 25.

[1.2 Operation]

The light emission waveform generating circuit 22 in the processing unit 53 of the signal processing unit 51 outputs the trigger signal TRG. The trigger signal TRG is input to the driver 10 via the coupling units 100a and 100b. The TDC 23a in the driver 10 starts counting time when the trigger signal TRG is input. The TDC 23a ends counting time when the drive unit 24 outputs the output signal OUT. The TDC 23a outputs the digital data corresponding to the delay time obtained by counting time. The TDC 23a sends the digital data corresponding to the delay time to the logic unit 25. The logic unit 25 stores the digital data corresponding to the delay time acquired from the TDC 23a in the storage unit 25M.

The processing unit 53 of the signal processing unit 51 accesses the logic unit 25 of the driver 10 via the coupling units 100d and 100e. The processing unit 53 acquires the digital data of the delay time stored in the storage unit 25M of the logic unit 25. The processing unit 53 sends the digital data of the delay time acquired from the storage unit 25M to the ranging observation unit 52. The ranging observation unit 52 calculates a distance D to a target 61 using the digital data corresponding to the delay time (hereinafter, it may be referred to as ranging.). That is, the ranging observation unit 52 performs ranging using the delay time. The ranging observation unit 52 subtracts the digital data corresponding to the delay time acquired from the storage unit 25M from a time period starting from timing at which the trigger signal TRG has been output to timing at which the ranging sensor unit 302 receives light. As a result, it is possible to know not the output timing of the trigger signal TRG but timing that is closer to the actual light emitting timing, and thus it is possible to remove the delay time attributable to an internal circuit of the driver 10. As a result, it is possible to obtain an effect of improving the accuracy of measurement of the distance D.

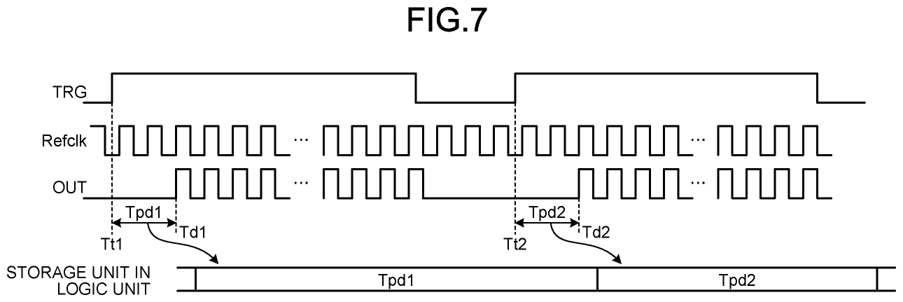

FIG. 7 is a timing chart illustrating an operation example of the ranging system 70b according to the first embodiment illustrated in FIG. 6. FIG. 7 is a diagram illustrating the trigger signal TRG, the clock signal Refclk, the output signal OUT, and the content stored in the storage unit 25M in the logic unit 25.

In FIG. 7, the TDC 23a starts counting time at the timing when the trigger signal TRG changes to a high level, that is, at rise time Tt1. In this example, the TDC 23a counts time by counting the number of clock signals Refclk. Then, the TDC 23a ends counting time at the timing when the output signal OUT changes to the high level, that is, at rise time Td1. The TDC 23a sends digital data of a time count value “Tpd1” to the logic unit 25. The logic unit 25 stores the digital data of the time count value in the storage unit 25M. Note that, if the repetition cycle of the clock signal Refclk is made shorter, counting time can be performed more accurately. The TDC 23a may count the number of signals other than the clock signal Refclk to count time.

The TDC 23a starts counting time at the timing when the trigger signal TRG changes to the high level at a subsequent time, that is, at rise time Tt2. The TDC 23a counts time by counting the number of clock signals Refclk. Then, the TDC 23a ends counting time at the timing when the output signal OUT changes to the high level, that is, at rise time Td2. The TDC 23a sends digital data of the time count value “Tpd2” to the logic unit 25. The logic unit 25 stores the digital data of the time count value “Tpd2” in the storage unit 25M.

Thereafter, digital data of time count values of the TDC 23a is similarly stored in the storage unit 25M. Digital data of a time count value stored in the storage unit 25M is delay time from input of the trigger signal TRG to actual light emission by the laser diode 12. That is, it is possible to measure time Tpd1 and time Tpd2 which are delay times described with reference to FIG. 5 and to store the digital data in the storage unit 25M.

[1.2.1 First Operation Example]

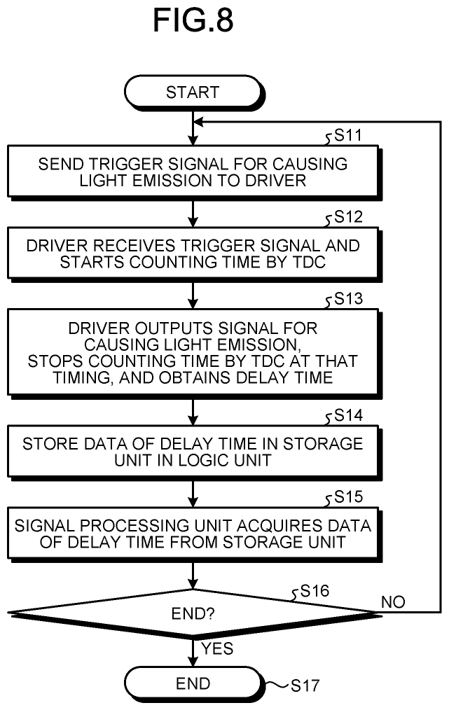

An operation example of the entire ranging system 70b illustrated in FIG. 6 will be described. FIG. 8 is a flowchart illustrating a first operation example of the ranging system 70b according to the first embodiment illustrated in FIG. 6.

In FIG. 8, the trigger signal TRG for causing the laser diode 12 to emit light is sent from the signal processing unit 51 to the driver 10 (step S11).

The driver 10 receives the trigger signal TRG and starts counting time by the TDC 23a (step S12). The driver 10 outputs a drive signal for causing the laser diode 12 to emit light, stops counting time by the TDC 23a at that timing, and obtains delay time (step S13). The driver 10 stores the digital data corresponding to the delay time in the storage unit 25M in the logic unit 25 (step S14).

The processing unit 53 of the signal processing unit 51 acquires digital data corresponding to the delay time from the storage unit 25M in the logic unit 25 (step S15).

Next, it is determined whether or not to end the process (step S16). If the process is not ended, the flow returns to step S11, and the above processes are performed (NO in step S16→S11). If the process is ended, the process ends (YES in step S16→S17).

Note that the above processes described with reference to FIG. 8 may be performed every time the laser diode 12 is caused to emit light or may be performed not every time but once every time the laser diode 12 is caused to emit light for a predetermined number of times. The above process may be performed at every predetermined time interval. The above process may be performed only at the time of activation of the system and not performed thereafter.

[1.2.2 Second Operation Example]

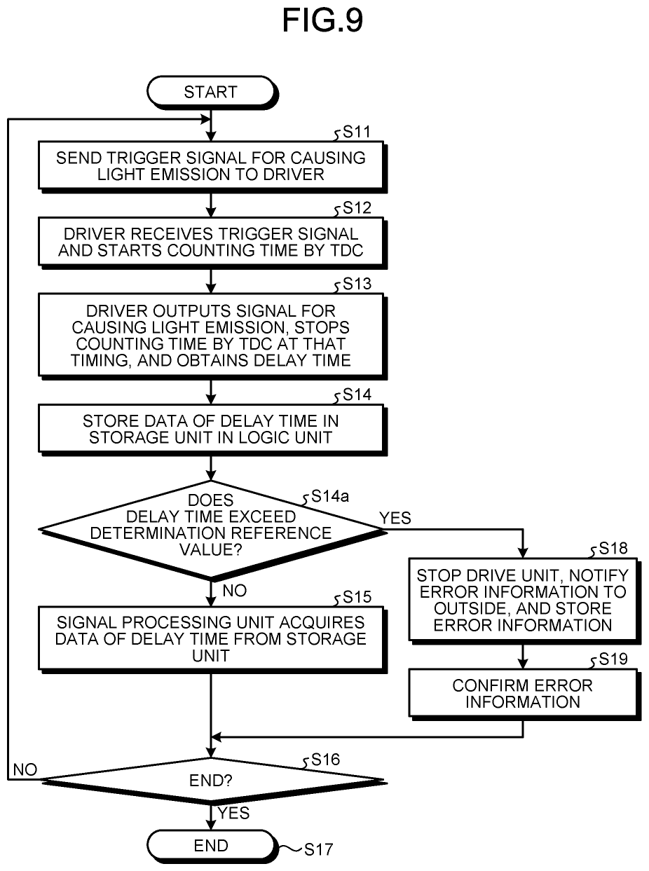

FIG. 9 is a flowchart illustrating a second operation example of the ranging system 70b according to the first embodiment illustrated in FIG. 6. In the second operation example, in a case where measured delay time exceeds a determination reference value, it is notified to the outside that the delay time is abnormal.

In FIG. 9, steps S11 to S14 are similar to the operation described by referring to FIG. 8. It is determined whether or not data of delay time stored in the storage unit in step S14 exceeds the determination reference value (step S14a). If the data of the delay time does not exceed the determination reference value, the process proceeds to step S15. In this case, the processing unit 53 of the signal processing unit 51 acquires digital data corresponding to the delay time from the storage unit 25M in the logic unit 25 (step S15).

Next, it is determined whether or not to end the process (step S16). If the process is not ended, the flow returns to step S11, and the above processes are performed (NO in step S16→S11). If the process is ended, the process ends (YES in step S16→S17).

In step S14a, if the data of the delay time exceeds the determination reference value, the process proceeds to step S18. In this case, the signal processing unit 51 stops the operation of the drive unit 24, notifies the error information to the outside, and stores the error information in a predetermined register (step S18). The signal processing unit 51 confirms the error information stored in the register (step S19). Then, the process proceeds to step S16.

Note that the above processes described with reference to FIG. 9 may be performed every time the laser diode 12 is caused to emit light or may be performed not every time but once every time the laser diode 12 is caused to emit light for a predetermined number of times. The above process may be performed at every predetermined time interval. The above process may be performed only at the time of activation of the system and not performed thereafter.

[1.3 Effects]

By using the digital data of the delay time for calculating the distance D to the target 61, the ranging observation unit 52 can know not the output timing of the trigger signal TRG but timing that is closer to the actual light emitting timing. As a result, the ranging observation unit 52 can remove the delay time attributable to an internal circuit of the driver 10. More specifically, the distance D to the target 61 can be calculated by measuring delay time that is included in a time period starting from the output timing of the trigger signal TRG to the timing at which the light emitting element actually emits light and being based on the output timing of the trigger signal TRG, the light receiving timing of the reflected light obtained by the ranging sensor unit 302, and the delay time. As a result, it is possible to obtain an effect of improving the accuracy of measurement of the distance D. In addition, the delay time can be measured using the light emission pattern signal generated by the light emission waveform generating circuit 22a.

(1.4 First Modification of First Embodiment)

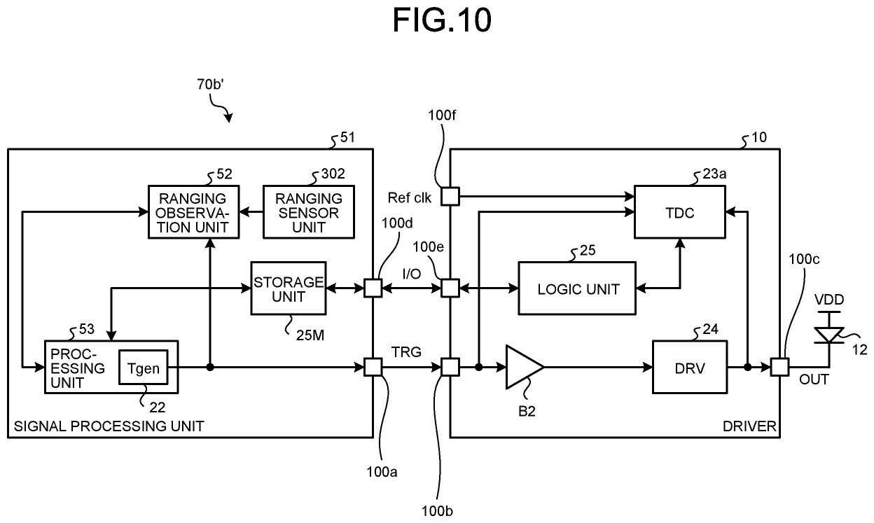

FIG. 10 is a diagram illustrating a ranging system 70b′ according to a first modification of the first embodiment described with reference to FIG. 6. In the ranging system 70b of the first modification, the storage unit 25M is included in the logic unit 25 of the driver 10. Meanwhile, the ranging system 70b′ of a second modification includes a storage unit 25M in a signal processing unit 51.

[1.4.1 Configuration]

The signal processing unit 51 of the ranging system 70b′ includes the storage unit 25M. A driver 10 does not include the storage unit 25M in a logic unit 25. Other configurations are similar to those of the ranging system 70b described with reference to FIG. 6, and thus description thereof will be omitted.

The storage unit 25M is only required to be provided in at least one of the signal processing unit 51 or the logic unit 25. The storage unit 25M may be provided in both the signal processing unit 51 and the logic unit 25, and the storage units 25M may exchange data.

[1.4.2 Operation]

A TDC 23a of the driver 10 sends digital data of a time count value to the logic unit 25. The logic unit 25 sends the digital data of the time count value to the signal processing unit 51. The signal processing unit 51 stores the digital data of the time count value in the storage unit 25M. Other operations are similar to the operations described by referring to FIGS. 7, 8, and 9.

[1.4.3 Effects]

Since the storage unit 25M is provided in the signal processing unit 51, the area of a chip of the driver 10 can be reduced.

(1.5 Second Modification of First Embodiment)

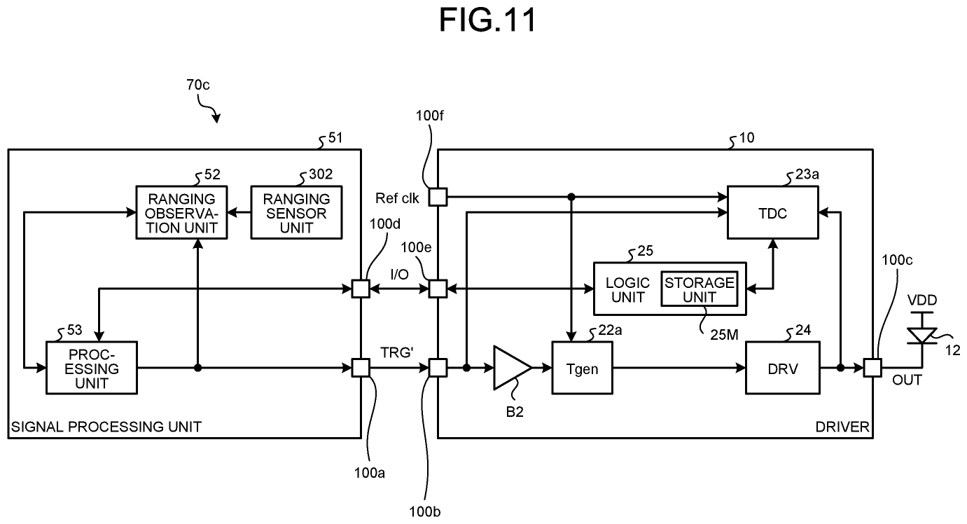

FIG. 11 is a diagram illustrating a ranging system 70c according to a second modification of the first embodiment described with reference to FIG. 6.

[1.5.1 Configuration]

In FIG. 11, the ranging system 70c has a light emission waveform generating circuit 22a provided in a driver 10. That is, the ranging system 70b described with reference to FIG. 6 has the light emission waveform generating circuit 22 provided in the processing unit 53 of the signal processing unit 51, whereas the ranging system 70c illustrated in FIG. 11 has the light emission waveform generating circuit 22a provided in the driver 10. When a trigger signal TRG′ is input, the light emission waveform generating circuit 22a operates the drive unit 24. Other configurations are similar to those of the ranging system 70b described with reference to FIG. 6, and thus description thereof will be omitted.

[1.5.2 Operation]

A processing unit 53 of the signal processing unit 51 outputs the trigger signal TRG′. The trigger signal TRG′ is input to the driver 10. When the trigger signal TRG′ is input via a buffer B2, the light emission waveform generating circuit 22a operates the drive unit 24.

The TDC 23a counts time from the timing at which the trigger signal TRG′ changes to a high level, that is, rise time, to the timing at which the output signal OUT output from the drive unit 24 changes to a high level, that is, rise time. The TDC 23a sends digital data of a time count value to the logic unit 25. The logic unit 25 stores the digital data of the time count value in the storage unit 25M. The subsequent operation is similar to the operations described by referring to FIGS. 7, 8, and 9.

[1.5.3 Effects]

By using the digital data corresponding to the delay time for calculating the distance D to the target 61, the ranging observation unit 52 can know not the output timing of the trigger signal TRG but timing that is closer to the actual light emitting timing. As a result, the ranging observation unit 52 can remove the delay time attributable to an internal circuit of the driver 10. As a result, it is possible to obtain an effect of improving the accuracy of measurement of the distance D.

(1.6 Third Modification of First Embodiment)

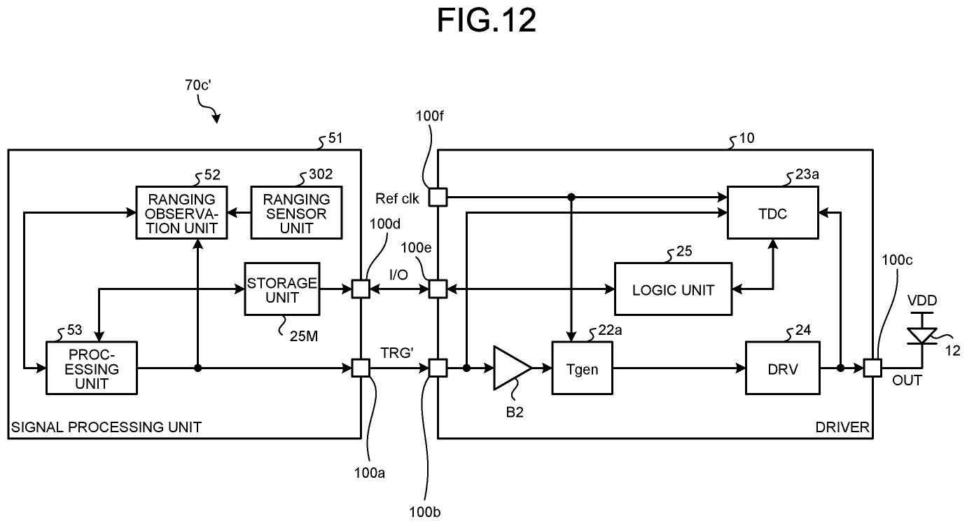

FIG. 12 is a diagram illustrating a ranging system 70c′ according to a third modification of the first embodiment described with reference to FIG. 6. The ranging system 70c of the second modification described with reference to FIG. 11 has the storage unit 25M in the logic unit 25 of the driver 10. Meanwhile, the ranging system 70c′ of the third modification has a storage unit 25M in a signal processing unit 51.

[1.6.1 Configuration]

The signal processing unit 51 of the ranging system 70c′ includes the storage unit 25M. A driver 10 does not include the storage unit 25M in a logic unit 25. Other configurations are similar to those of the ranging system 70c described with reference to FIG. 6, and thus description thereof will be omitted.

[1.6.2 Operation]

A TDC 23a of the driver 10 sends digital data of a time count value to the logic unit 25. The logic unit 25 sends the digital data of the time count value to the signal processing unit 51. The signal processing unit 51 stores the digital data of the time count value in the storage unit 25M. Other operations are similar to the operations described by referring to FIGS. 7, 8, and 9.

[1.6.3 Effects]

Since the storage unit 25M is provided in the signal processing unit 51, the area of a chip of the driver 10 can be reduced.

(1.7 Fourth Modification of First Embodiment)

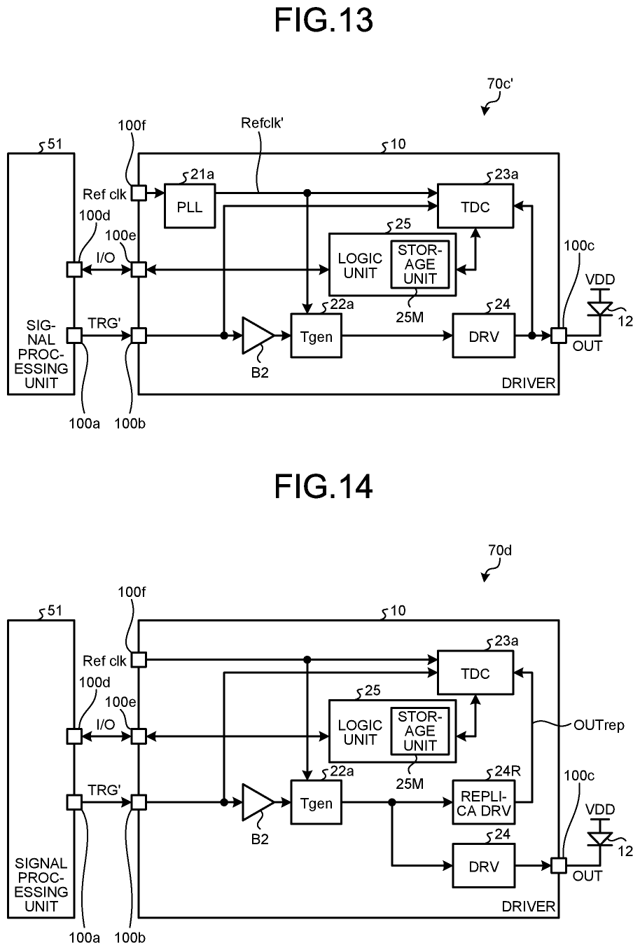

FIG. 13 is a diagram illustrating a ranging system 70c′ according to a fourth modification of the first embodiment described with reference to FIG. 6.

[1.7.1 Configuration]

The ranging system 70c′ illustrated in FIG. 13 has a configuration in which a PLL unit 21a is added in the driver 10 of the ranging system 70c described with reference to FIG. 11. The PLL unit 21a receives a clock signal Refclk as input and outputs a clock signal Refclk′ having a phase matching the phase of the clock signal Refclk.

Other configurations in the driver 10 are similar to those described with reference to FIG. 11. Note that, in FIG. 13, the configuration of the signal processing unit 51 is similar to the configuration described with reference to FIG. 11. Therefore, illustration and description of the internal configuration of the signal processing unit 51 are omitted.

[1.7.2 Operation]

The PLL unit 21a receives a clock signal Refclk as input and outputs a clock signal Refclk′ having a phase matching the phase of the clock signal Refclk. The clock signal Refclk′ is input to a TDC 1. The TDC 1 counts time on the basis of the clock signal Refclk′. The subsequent operation is similar to the operations described by referring to FIGS. 7, 8, and 9.

[1.7.3 Effects]

By using the digital data of the delay time for calculating the distance D to the target 61, the ranging observation unit 52 can know not the output timing of the trigger signal TRG but timing that is closer to the actual light emitting timing. As a result, the ranging observation unit 52 can remove the delay time attributable to an internal circuit of the driver 10. As a result, it is possible to obtain an effect of improving the accuracy of measurement of the distance D.

(1.8 Fifth Modification of First Embodiment)

FIG. 14 is a diagram illustrating a ranging system 70d according to a fifth modification of the first embodiment described with reference to FIG. 6.

[1.8.1 Configuration]

In FIG. 11, the ranging system 70d according to the fifth modification of the first embodiment includes a replica drive unit 24R imitating a drive unit 24, separately from the original drive unit 24. The replica drive unit 24R has a configuration similar to that of the drive unit 24. In this example, a path from a waveform generating circuit 22a to the drive unit 24 is branched, and the replica drive unit 24R is disposed in the middle of a branched path.

The replica drive unit 24R outputs a replica output signal OUTrep, which simulates the output signal OUT output by the drive unit 24, on the basis of a signal output by the waveform generating circuit 22a. The replica drive unit 24R either constantly outputs the replica output signal OUTrep (in the case of a first operation example to be described later) or operates similarly to the drive unit 24 and outputs the replica output signal OUTrep which is the same as the output signal OUT (in the case of a second operation example to be described later).

Other configurations in the driver 10 are similar to those described with reference to FIG. 11. Note that, in FIG. 14, the configuration of the signal processing unit 51 is similar to the configuration described with reference to FIG. 11. Therefore, illustration and description of the internal configuration of the signal processing unit 51 are omitted.

[1.8.2 Operation]

In FIG. 11, when the signal processing unit 51 outputs the trigger signal TRG′, the trigger signal TRG′ is input to the driver 10. The waveform generating circuit 22a in the driver 10 outputs a signal for causing the drive unit 24 and the replica drive unit 24R to output the output signal OUT and the replica output signal OUTrep, respectively. The drive unit 24 outputs the output signal OUT, and the replica drive unit 24R outputs the replica output signal OUTrep. The TDC 23a starts counting time from the time when the trigger signal TRG′ rises and ends counting time by the replica output signal OUTrep output from the replica drive unit 24R. The TDC 23a sends digital data of a time count value to the logic unit 25. The logic unit 25 stores the digital data of the time count value in the storage unit 25M. The subsequent operation is similar to the operations described by referring to FIGS. 7, 8, and 9.

[1.8.2.1 Operation Example]

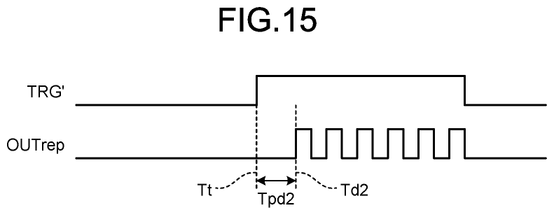

FIG. 15 is a timing chart illustrating an operation example of the ranging system 70d according to the fifth modification of the first embodiment illustrated in FIG. 14. The TDC 23a counts time from time Tt when the trigger signal TRG′ rises to time Td2 when the replica output signal OUTrep rises. In this manner, delay time Tpd2 can be obtained.

[1.8.3 Effects]

There are cases where it is not desired to provide a path branching to the TDC 23a on the output side of the original drive unit 24 and the laser diode 12. For example, the path branching to the TDC 23a may affect the current value of the output signal OUT to the laser diode 12. In this example, since the delay time is measured using the replica drive unit 24R, it is possible to obtain an effect that there is no such influence.

(1.9 Sixth Modification of First Embodiment)

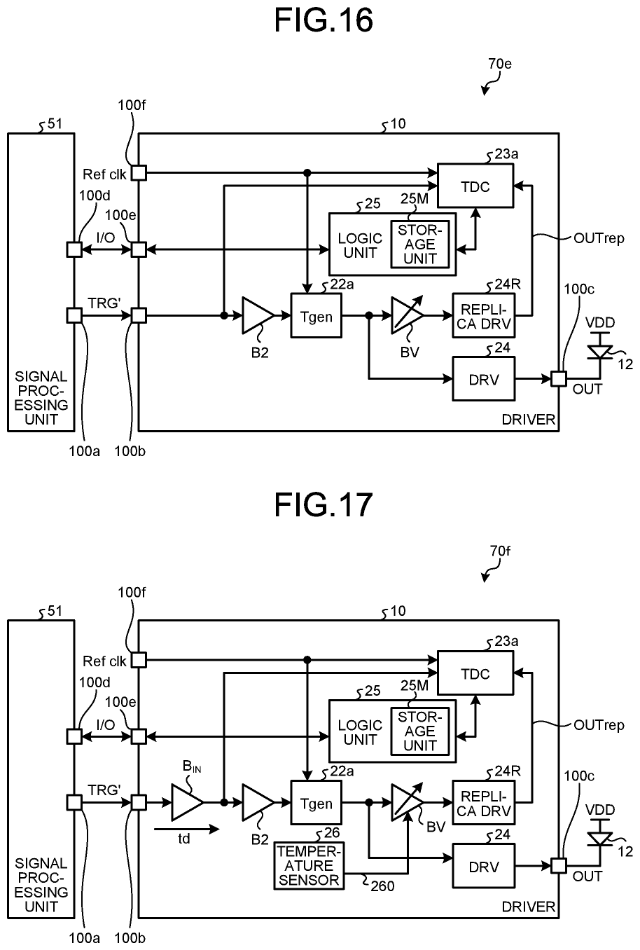

FIG. 16 is a diagram illustrating a ranging system 70e according to a sixth modification of the first embodiment described with reference to FIG. 6.

[1.9.1 Configuration]

The ranging system 70e illustrated in FIG. 16 has a configuration in which a buffer BV is added to the ranging system 70d described with reference to FIG. 14. The buffer BV is provided on the input side of a replica drive unit 24R. In the buffer BV, the delay amount is adjustable. The delay amount of the buffer BV is adjusted so that the delay time of a signal passing through the replica drive unit 24R and the buffer BV matches the delay time by the drive unit 24. The buffer BV functions as a delay amount adjusting unit for adjusting delay time of a signal passing through the replica drive unit 24R.

Other configurations in the driver 10 are similar to those described with reference to FIG. 11. Note that, in FIG. 16, the configuration of the signal processing unit 51 is similar to the configuration described with reference to FIG. 11. Therefore, illustration and description of the internal configuration of the signal processing unit 51 are omitted.

[1.9.2 Operation]

In FIG. 16, when the signal processing unit 51 outputs the trigger signal TRG′, the trigger signal TRG′ is input to the driver 10. The waveform generating circuit 22a in the driver 10 outputs a signal for causing the drive unit 24 and the replica drive unit 24R to output the output signal OUT and the replica output signal OUTrep, respectively. The drive unit 24 outputs the output signal OUT, and the replica drive unit 24R outputs the replica output signal OUTrep.

Here, by adjusting the delay amount of the buffer BV, it becomes possible to match the timing at which the drive unit 24 outputs the output signal OUT to cause the laser diode 12 to emit light with the timing at which the replica output signal OUTrep from the buffer BV and the replica drive unit 24R is input to the TDC 23a.

The TDC 23a starts counting time from the time when the trigger signal TRG′ rises and ends counting time at the output timing of the replica output signal OUTrep output from the replica drive unit 24R. The TDC 23a sends digital data of a time count value to the logic unit 25. The logic unit 25 stores the digital data of the time count value in the storage unit 25M. The subsequent operation is similar to the operations described by referring to FIGS. 7, 8, and 9.

[1.9.3 Effects]

There are cases where it is not desired to provide a path branching to the TDC 23a on the output side of the original drive unit 24 and the laser diode 12. For example, the path branching to the TDC 23a may affect the current value of the output signal OUT to the laser diode 12. In this example, since the delay time is measured using the replica drive unit 24R, it is possible to obtain an effect that there is no such influence.

In addition, by adjusting the delay amount of the buffer BV, it becomes possible to match the timing at which the laser diode 12 is caused to emit light with the timing at which the replica output signal OUTrep is input to the TDC 23a. As a result, the delay time can be measured more accurately, and the ranging accuracy can be improved.

(1.10 Seventh Modification of First Embodiment)

FIG. 17 is a diagram illustrating a ranging system 70f according to a seventh modification of the first embodiment described with reference to FIG. 6.

[1.10.1 Configuration]

A ranging system 70f illustrated in FIG. 17 has a configuration in which a temperature sensor 26 and an input buffer B_{IN} are added to the ranging system 70e described with reference to FIG. 16. An output signal of the input buffer B_{IN} is input to a buffer B2 and is also input to a TDC 23a. The temperature sensor 26 detects the temperature of a driver 10. The delay amount of the buffer BV is adjusted on the basis of the temperature of the driver 10 detected by the temperature sensor 26.

Other configurations in the driver 10 are similar to those described with reference to FIG. 11. Note that, in FIG. 17, the configuration of the signal processing unit 51 is similar to the configuration described with reference to FIG. 11. Therefore, illustration and description of the internal configuration of the signal processing unit 51 are omitted.

[1.10.2 Operation]

In FIG. 17, the temperature sensor 26 outputs a detection signal 260 corresponding to the temperature of the driver 10. The detection signal 260 is input to the buffer BV. The delay amount of the buffer BV is adjusted on the basis of the detection signal 260. Even if the temperature of the driver 10 changes, the delay amount of the buffer BV is adjusted so that the delay time of a signal passing through the replica drive unit 24R and the buffer BV matches the delay time by the drive unit 24. Other operations are similar to the operation described by referring to FIG. 16.

[1.10.3 Effects]

There are cases where it is not desired to provide a path branching to the TDC 23a on the output side of the original drive unit 24 and the laser diode 12. For example, the path branching to the TDC 23a may affect the current value of the output signal OUT to the laser diode 12. In this example, since the delay time is measured using the replica drive unit 24R, it is possible to obtain an effect that there is no such influence.

Furthermore, by adjusting the delay amount of the buffer BV on the basis of the temperature of the driver 10, it is possible to match the timing at which the laser diode 12 is caused to emit light with the timing at which the replica output signal OUTrep is input to the TDC 23a. As a result, the delay time can be measured more accurately, and the ranging accuracy can be improved.

(1.11 Eighth Modification of First Embodiment)

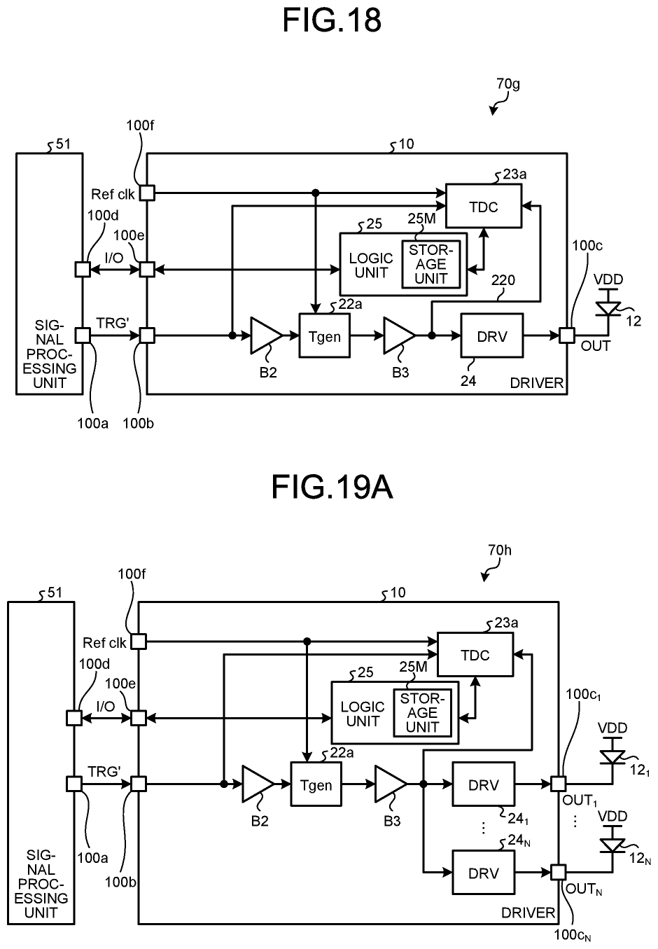

FIG. 18 is a diagram illustrating a ranging system 70g according to an eighth modification of the first embodiment described with reference to FIG. 6.

[1.11.1 Configuration]

The ranging system 70g illustrated in FIG. 18 has a configuration in which a signal on the input side of a drive unit 24 is input to a TDC 23a instead of an output signal OUT of the drive unit 24. For example, in a case where the output signal OUT of the drive unit 24 cannot be used due to mounting circumstances of a driver 10, it is possible to count time using a signal on the input side of the drive unit 24. That is, counting time is ended at the output timing of the signal on the input side of the drive unit 24. In this example, a buffer B3 is disposed between a light emission waveform generating circuit 22a and the drive unit 24, and an output signal 220 of the buffer B3 is input to the TDC 23a.

Other configurations in the driver 10 are similar to those described with reference to FIG. 11. Note that, in FIG. 18, the configuration of the signal processing unit 51 is similar to the configuration described with reference to FIG. 11. Therefore, illustration and description of the internal configuration of the signal processing unit 51 are omitted.

[1.11.2 Operation]

In FIG. 18, a processing unit 53 of the signal processing unit 51 outputs a trigger signal TRG′. The trigger signal TRG′ is input to the driver 10. When the trigger signal TRG′ is input via a buffer B2, the light emission waveform generating circuit 22a operates the drive unit 24.

The TDC 23a counts time from the timing at which a trigger signal TRG′ changes to a high level, that is, rise time, to the timing at which the output signal 220 of the buffer B3 changes to a high level, that is, rise time. The TDC 23a sends digital data of a time count value to the logic unit 25. The logic unit 25 stores the digital data of the time count value in the storage unit 25M. The subsequent operation is similar to the operations described by referring to FIGS. 7, 8, and 9.

[1.11.3 Effects]

In a case where the output signal OUT of the drive unit 24 cannot be used due to mounting circumstances of the driver 10, it is possible to improve the ranging accuracy by counting time using a signal on the input side of the drive unit 24.

(1.12 Ninth Modification of First Embodiment)

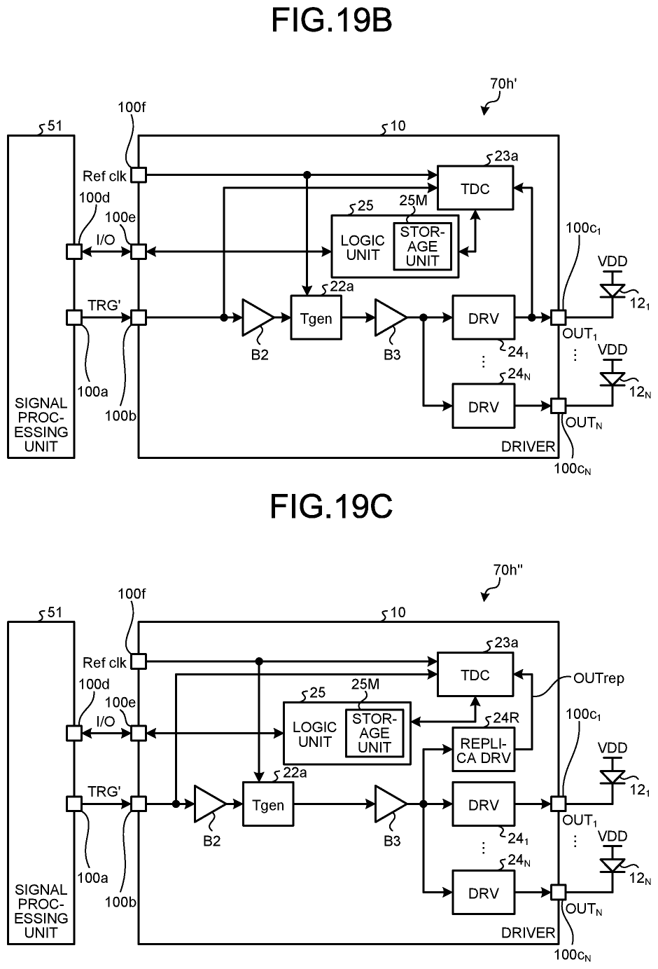

FIGS. 19A, 19B, and 19C are diagrams illustrating ranging systems 70h, 70h′, and 70h″ of a ninth modification of the first embodiment described with reference to FIG. 6.

[1.12.1 Configuration]

In FIGS. 19A, 19B, and 19C, the ranging systems 70h, 70h′, and 70h″ each include a plurality of drive units 24₁ to 24_{N} corresponding to a plurality of laser diodes 12₁ to 12_{N}, respectively (N is an integer greater than or equal to 2). In FIGS. 19A, 19B, and 19C, the ranging systems 70h, 70h′, and 70h″ each include coupling units 100c₁ to 100c_{N} corresponding to the plurality of laser diodes 12₁ to 12_{N}, respectively. Output signals OUT₁ to OUT_{N} are output from the coupling unit 100c₁ to 100c_{N} and input to the corresponding laser diodes 12₁ to 12_{N}, respectively.

In a case where a plurality of drive units 24₁ to 24_{N} is included, it is conceivable to measure the delay time for all the drive units 24₁ to 24_{N}. However, in that case, wiring becomes complicated, which is not realistic. Therefore, it is conceivable to set a part of the plurality of drive units 24₁ to 24_{N} as a measurement target. The measurement result of the drive unit as the measurement target can be used for ranging by all the other drive units.

The ranging system 70h illustrated in FIG. 19A measures the delay time using an output signal 220 of a buffer B3 similarly to the ranging system 70g described with reference to FIG. 18. The output signal 220 of the buffer B3 is the same signal as the signal input to the drive units 24₁ to 24_{N}. Other configurations are similar to those of the ranging system 70g described with reference to FIG. 18, and thus description thereof is omitted.

The ranging system 70h′ illustrated in FIG. 19B measures the delay time using an output signal of one drive unit 24₁ among the plurality of drive units 24₁ to 24_{N}. Other configurations are similar to those of the ranging system 70c described with reference to FIG. 11, and thus description thereof is omitted.

The ranging system 70h″ illustrated in FIG. 19C measures the delay time using an output signal OUTrep of a replica drive unit 24R, similarly to the ranging system 70d described with reference to FIG. 14. Other configurations are similar to those of the ranging system 70d described with reference to FIG. 14, and thus description thereof is omitted.

[1.12.2 Operation]

The ranging system 70h illustrated in FIG. 19A measures the delay time using the output signal 220 of the buffer B3. The output signal 220 of the buffer B3 is the same signal as the signal input to the drive units 24₁ to 24_{N}. Therefore, the ranging system 70h illustrated in FIG. 19A measures the delay time using the output signal 220 before the output signal 220 branches to the paths to the respective drive units 24₁ to 24_{N}. Ranging is performed on the basis of the delay time measured. Other operations are similar to those of the ranging system 70g described with reference to FIG. 18, and thus description thereof is omitted.

The ranging system 70h′ illustrated in FIG. 19B measures the delay time using a drive signal of one drive unit 24₁ among the plurality of drive units 24₁ to 24_{N}. That is, counting time is started from the rise timing of a trigger signal TRG′, counting time is ended at the output timing of the drive signal of the one drive unit 24₁ among the plurality of drive units 24₁ to 24_{N}, and the time count value is set as the delay time. For the other drive unit 24₂ to 24_{N}, ranging is performed on the basis of the delay time measured using the output signal OUT₁ of the drive unit 24₁. Other operations are similar to those of the ranging system 70c described with reference to FIG. 11, and thus description thereof is omitted.

The ranging system 70h″ illustrated in FIG. 19C measures the delay time using the output signal OUTrep of the replica drive unit 24R. Other operations are similar to those of the ranging system 70d described with reference to FIG. 14, and thus description thereof is omitted.

[1.12.3 Effects]

In a case where a plurality of drive units 24₁ to 24_{N} is included, by using an output signal before branching or by using some drive units as measurement targets, it is possible to prevent the wiring from becoming complicated, to measure the delay time, and to improve the ranging accuracy.

(1.13 Tenth Modification of First Embodiment)

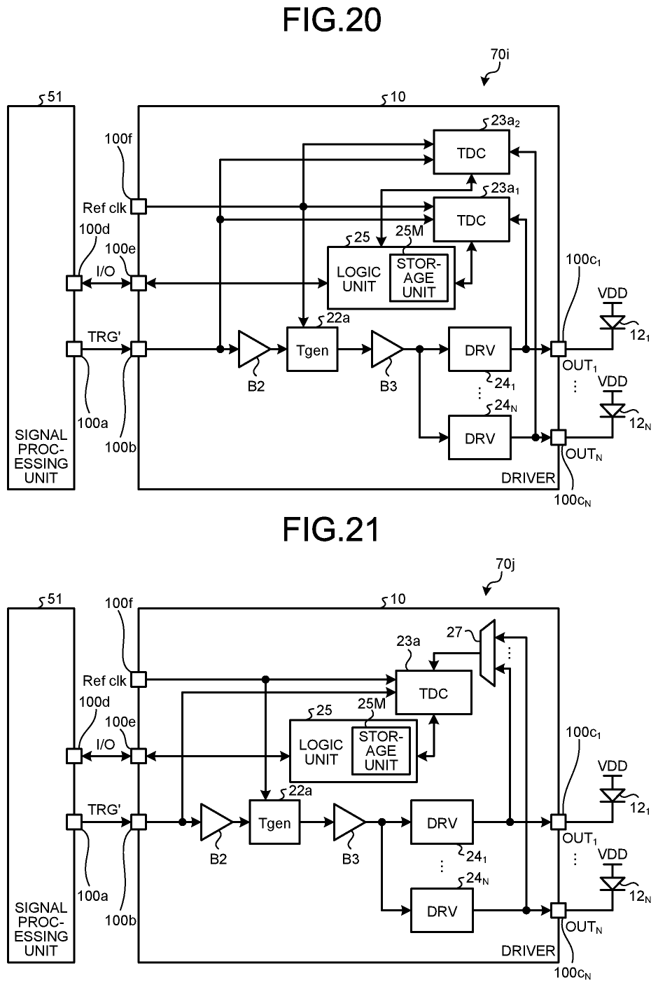

FIG. 20 is a diagram illustrating a ranging system 70i according to a tenth modification of the first embodiment described with reference to FIG. 6.

[1.13.1 Configuration]

The ranging system 70i illustrated in FIG. 20 includes a plurality of TDCs 23a. In the present example, the ranging system 70i includes two TDCs 23a₁ and 23a₂. The TDC 23a₁ receives input of an output signal OUT₁ of the drive unit 24₁. The TDC 23a₂ receives an output signal OUT_{N} of the drive unit 24_{N}. Other configurations are similar to those of the ranging system 70c described with reference to FIG. 11, and thus description thereof is omitted.

[1.13.2 Operation]

In the ranging system 70i illustrated in FIG. 20, the TDC 23a₁ and the TDC 23a₂ each measure a delay time. Digital data of the delay times measured by the two TDCs 23a₁ and 23a₂ is stored in a storage unit 25M in a logic unit 25. Other operations are similar to those of the ranging system 70c described with reference to FIG. 11, and thus description thereof is omitted. Note that the ranging system 70i may include three or more TDCs.

[1.13.3 Effects]

In the ranging system 70i illustrated in FIG. 20, a signal processing unit 51 can acquire the digital data of the delay times stored in the storage unit 25M in the logic unit 25. In this example, the signal processing unit 51 can acquire the digital data of the delay times measured by each of the two TDC 23a₁ and TDC 23a₂. Therefore, the signal processing unit 51 can perform ranging using the two pieces of digital data that have been acquired. For example, it is possible to calculate an average value of the two pieces of digital data to perform ranging using the average value, thereby allowing the ranging accuracy to be further improved.

(1.14 Eleventh Modification of First Embodiment)

FIG. 21 is a diagram illustrating a ranging system 70j according to an eleventh modification of the first embodiment described with reference to FIG. 6.

[1.14.1 Configuration]

The ranging system 70j illustrated in FIG. 21 includes a plurality of drive units 24₁ to 24_{N} and a selector 27. The selector 27 selects each drive signal of the plurality of drive units 24₁ to 24_{N}. The selector 27 may sequentially select the drive signals of the plurality of drive units 24₁ to 24_{N}. The selector 27 may select drive signals of the plurality of drive units 24₁ to 24_{N} by a selection signal (not illustrated).

Other configurations in the driver 10 are similar to those described with reference to FIG. 11. Note that, in FIG. 20, the configuration of the signal processing unit 51 is similar to the configuration described with reference to FIG. 11. Therefore, illustration and description of the internal configuration of the signal processing unit 51 are omitted.

[1.14.2 Operation]

In the ranging system 70j illustrated in FIG. 21, the selector 27 selects one of drive signals of the plurality of drive units 24₁ to 24_{N}. The selector 27 may sequentially select one of the drive signals of the plurality of drive units 24₁ to 24_{N}. The drive signal selected by the selector 27 is input to the TDC 23a. The TDC 23a measures the delay time using the drive signal selected by the selector 27. That is, counting time is started from the rise timing of a trigger signal TRG′, counting time is ended at the output timing of the drive signal selected by the selector 27 from the drive signals of the plurality of drive units 24₁ to 24_{N}, and the time count value is set as the delay time. Other operations are similar to those of the ranging system 70c described with reference to FIG. 11, and thus description thereof is omitted.

[1.14.3 Effects]

Since the ranging system 70j illustrated in FIG. 21 includes the selector 27, there is an effect that the wiring is not complicated and the mounting area is not increased as compared with a case where a TDC 23a is provided corresponding to all output signals of a plurality of drive units 24₁ to 24_{N}.

### 2. Second Embodiment

Next, a second embodiment of the present disclosure will be described. In the first embodiment, the driver 10 measures the delay time. Meanwhile, in the second embodiment, a signal processing unit 51 measures the delay time.

[2.1 Configuration]

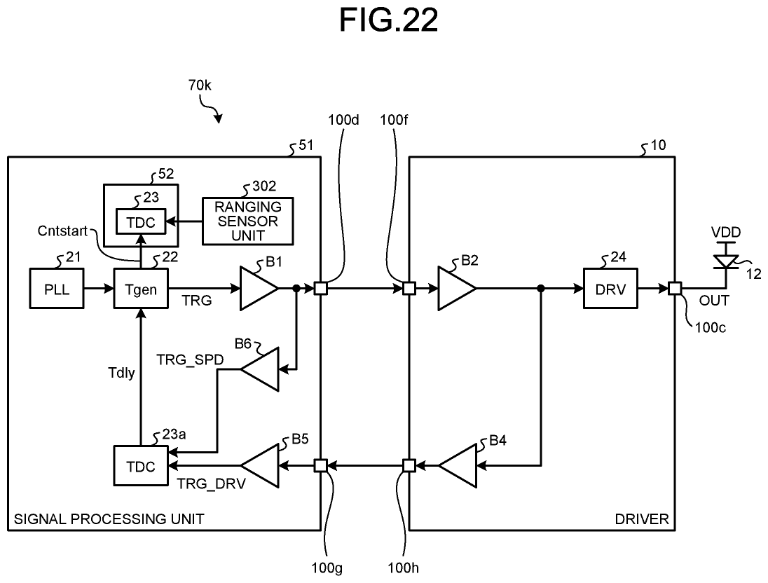

FIG. 22 is a diagram illustrating a ranging system 70k according to a second embodiment of the present disclosure. In FIG. 22, the ranging system 70k includes a signal processing unit 51, a driver 10, and a laser diode 12. The signal processing unit 51 and the driver 10 are coupled by coupling units 100a and 100b and coupling units 100g and 100h. The driver 10 and the laser diode 12 are coupled by a coupling unit 100c.

The signal processing unit 51 includes a PLL unit 21, a light emission waveform generating circuit (Tgen) 22 as a light emission waveform generating unit, TDCs 23 and 23a, buffers B1, B5, and B6, and a ranging sensor unit 302. The light emission waveform generating circuit 22 outputs trigger signal TRG. The trigger signal TRG is a light emission pattern signal for causing the laser diode 12 to emit light. The light emission waveform generating circuit 22 outputs the trigger signal TRG and outputs a count start signal Cntstart. The buffer B5 receives the trigger signal TRG output from the buffer B1 as input and outputs the trigger signal TRG toward the TDC 23a. The buffer B6 receives a signal input from the coupling unit 100g and outputs the signal toward the TDC 23a. The buffers B5 and B6 include, for example, two CMOS inverters connected in cascade.

Like the TDC 23, the TDC 23a includes a counter for counting time. The TDC 23a starts counting time when the signal output from the buffer B5 is input. The TDC 23a ends the counting time when the signal output from the buffer B6 is input. Although the timing at which the laser diode 12 actually emits light is unknown, in this example, the time until the timing immediately before the light emission, which is close to the light emitting timing, is measured as a delay time. That is, the TDC 23a functions as a measurement unit that measures a delay time that is a time included in the time from the timing at which the trigger signal TRG for causing the laser diode 12 to emit light is output to the timing at which the laser diode 12 actually emits light. Other configurations of the signal processing unit 51 are similar to those of the ranging system 70a described with reference to FIG. 4, and thus description thereof is omitted.

The driver 10 includes buffers B2 and B4 and a drive unit 24. A signal on the input side of the drive unit 24 is branched. The branched signal is derived from the light emitting timing and is input to the buffer B4. The buffer B4 returns the branched signal to the signal processing unit 51. The buffer B4 receives the signal output from the buffer B2 and outputs the signal to the signal processing unit 51 via the coupling units 100g and 100h. Other configurations of the driver 10 are similar to those of the ranging system 70a described with reference to FIG. 4, and thus description thereof is omitted.

[2.2 Operation]

The TDC 23a functioning as a measurement unit bifurcates the transmission path of the trigger signal TRG in the signal processing unit 51 and starts counting time from the rise timing of a returned signal. Then, the TDC 23a bifurcates the transmission path of the trigger signal TRG on the input side of the drive unit 24, ends counting time at the rise timing of the signal obtained by returning the trigger signal TRG, and sets the time count value as the delay time. That is, the trigger signal TRG for causing the laser diode 12 to emit light is output, and ranging is performed using the delay time generated by a delay element in the path extending to a point where the trigger signal TRG actually drives the laser diode 12. That is, a time difference between signals returned through different systems is measured as a delay time, and ranging is performed using the delay time.

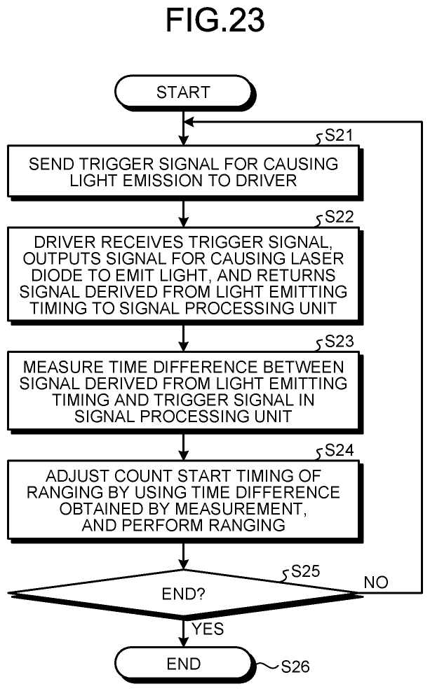

An operation example of the entire ranging system 70k illustrated in FIG. 22 will be described. FIG. 23 is a flowchart illustrating an operation example of the ranging system 70k according to the second embodiment of the present disclosure illustrated in FIG. 22.

In FIG. 22, the signal processing unit 51 sends the trigger signal TRG for causing the laser diode 12 to emit light to the driver 10 (step S21). The driver 10 receives the trigger signal TRG, outputs a drive signal for causing the laser diode 12 to emit light, and returns a signal derived from the light emitting timing to the signal processing unit 51 (step S22).

The signal processing unit 51 measures a time difference between the signal derived from the light emitting timing and the trigger signal TRG, that is, a delay time (step S23). The signal processing unit 51 adjusts the count start timing for ranging using the time difference obtained by the measurement, that is, the delay time, and performs ranging (step S24).

Specifically, in the TDC 23a, the count start timing for ranging is delayed by a time corresponding to the delay time. That is, the TDC 23a starts counting time after elapse of the time corresponding to the delay time from the output timing of the trigger signal TRG and ends counting time at the light receiving timing of the reflected light obtained by the ranging sensor unit 302. The signal processing unit 51 calculates the distance to the target 61 on the basis of the time count result of the TDC 23a. As a result, ranging can be performed by adjusting the start timing of counting time.

Next, it is determined whether or not to end the process (step S25). If the process is not ended, the flow returns to step S21, and the above process is performed (NO in step S25→S21). If the process is ended, the process ends (YES in step S25→S26).

The above processes described with reference to FIG. 23 may be performed every time the laser diode 12 is caused to emit light or may be performed not every time but once every time the laser diode 12 is caused to emit light for a predetermined number of times. The above process may be performed at every predetermined time interval. The above process may be performed only at the time of activation of the system and not performed thereafter.

Note that, similarly to the first embodiment, a storage unit 25M may be provided, and digital data corresponding to the delay time measured in step S23 may be stored in the storage unit 25M. In this case, the count start timing for ranging is adjusted in step S24 using the digital data of the delay time stored in the storage unit 25M.

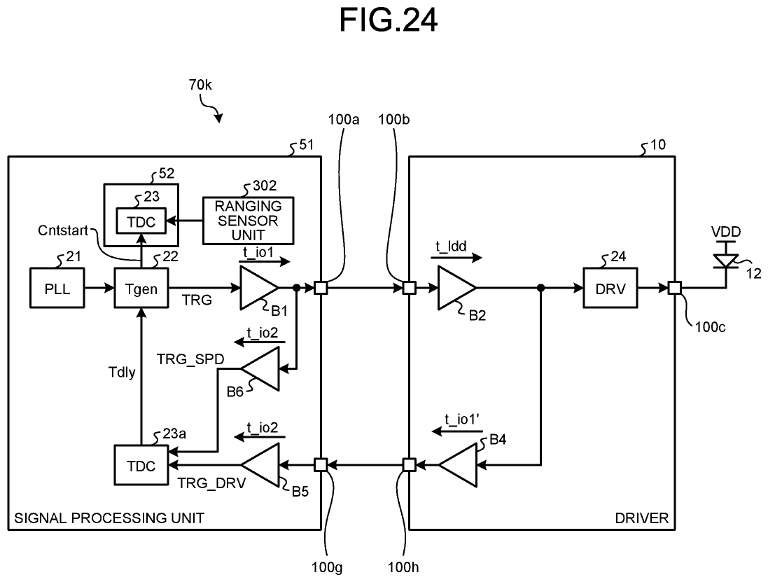

Here, an exemplary calculation of delay time by the ranging system 70k according to the second embodiment illustrated in FIG. 22 will be described. FIG. 24 is a diagram for explaining an exemplary calculation of the delay time by the ranging system 70k. In FIG. 24, let t_io1 be a delay time by the buffer B1, t_ldd be a delay time by the buffer B2, t_io1′ be a delay time by the buffer B4, t_io2 be a delay time by the buffer B5, and t_io2 be a delay time by the buffer B6. The delay time by the buffer B5 is equal to the delay time by the buffer B6. Since the buffer B5 and the buffer B6 are formed on the same semiconductor chip, the delay times of the buffer B5 and the buffer B6 can be matched with each other.

A delay time caused by a path through which the trigger signal TRG is input to the TDC 23a via the buffers B1 and B6 in the signal processing unit 51 is denoted by T1. That is, the difference between the time when the trigger signal TRG is output and the time when a signal TRG_SPD corresponding to the trigger signal TRG is input to the TDC 23a is the delay time T1. The delay time T1 can be expressed by the following Equation (2).

T1=t_io1+t_ldd+t_io1′+t_io2 (2)

In addition, a delay time caused by a path in which the trigger signal TRG travels from the signal processing unit 51 to the driver 10 and returns to the signal processing unit 51 via the driver 10 is denoted by T2. The difference between the time when the trigger signal TRG is output and the time when the signal TRG_DRV derived from the trigger signal TRG is input to the TDC 23a is the delay time T2. The delay time T2 can be expressed by the following Equation (3).

T2=t_io1+t_io2 (3)

On the basis of Equations (2) and (3), the difference between the delay time T1 and the delay time T2 is expressed by the following Equation (4).

T1−T2=t_ldd+t_io1′ (4)

Equation (4) is equivalent to a delay time Tdly measured by the TDC 23a. The delay time Tdly is input to a light emission waveform generating circuit 22 which is a light emission waveform generating unit. The light emission waveform generating circuit 22 delays the rise timing of a count start signal Cntstart by a time corresponding to the delay time Tdly. The delay time Tdly is a difference between the delay time in the signal processing unit 51 and the delay time in the driver 10, and the accuracy of ranging can be improved by using the delay time Tdly.

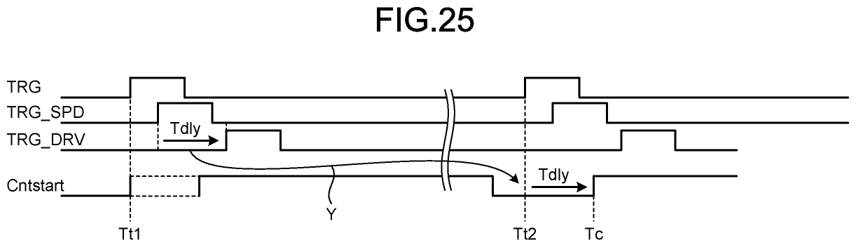

Furthermore, rise timing of main signals of the ranging system 70k illustrated in FIG. 22 will be described. FIG. 25 is a diagram illustrating an example of the rise timing of the trigger signal TRG, the signal TRG_SPD corresponding to the trigger signal TRG, the signal TRG_DRV derived from the trigger signal TRG, and the count start signal Cntstart in FIG. 24.

As illustrated in FIG. 25, the signal TRG_SPD rises with a delay from the rise time Tt1 of the trigger signal TRG, and the signal TRG_DRV rises with a further delay. The time difference between the rise timing of the signal TRG_SPD and the rise timing of the signal TRG_DRV is the delay time Tdly.

The light emission waveform generating circuit 22 can use the delay time Tdly to adjust the next or subsequent rise timing of the count start signal Cntstart. That is, as indicated by an arrow Y in FIG. 25, the count start signal Cntstart rises at a rise timing Tc delayed by the delay time Tdly from the rise time Tt2 of the trigger signal TRG. In this manner, the count start time of the TDC 23a can be matched with or brought closer to the actual light emitting timing.

[2.3 Effects]

By using the delay time Tdly which is a difference between the delay time in the signal processing unit 51 and the delay time in the driver 10, the count start time of the TDC 23a can be matched with or brought closer to the actual light emitting timing. As a result, the accuracy of ranging can be further improved.

(2.4 First Modification of Second Embodiment)

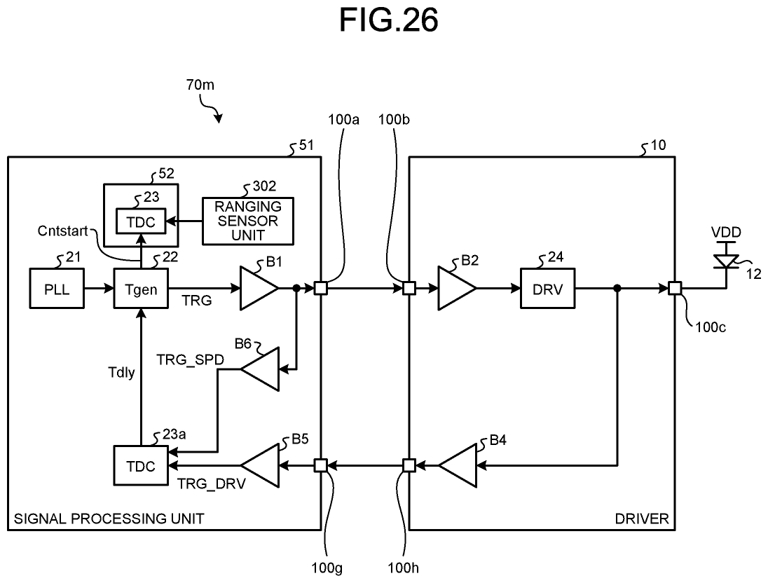

FIG. 26 is a diagram illustrating a ranging system 70m according to a first modification of the second embodiment described with reference to FIG. 22.

[2.4.1 Configuration]

In the ranging system 70k of the second embodiment described with reference to FIGS. 22 to 25, the path on the output side of the buffer B2 in the driver 10, that is, the input side of the drive unit 24 is bifurcated to return a signal to the signal processing unit 51. Meanwhile, as illustrated in FIG. 26, the ranging system 70m according to the first modification of the second embodiment bifurcates a path on the output side of the drive unit 24 in the driver 10 and returns a signal to a signal processing unit 51. Other configurations are the same as those of the ranging system 70k of the second embodiment, and thus description thereof will be omitted.

[2.4.2 Operation]

The ranging system 70m according to the first modification of the second embodiment illustrated in FIG. 26 bifurcates a path on the output side of a drive unit 24 in the driver 10 and returns a signal to the signal processing unit 51 via a buffer B4. Other operations are the same as those of the ranging system 70k of the second embodiment, and thus description thereof will be omitted.

[2.4.3 Effects]

In the ranging system 70m according to the first modification of the second embodiment, a subsequent stage of the drive unit 24, that is, a point close to the laser diode 12 is set as a measurement target. Therefore, the accuracy of ranging can be further improved.

(2.5 Second Modification of Second Embodiment)

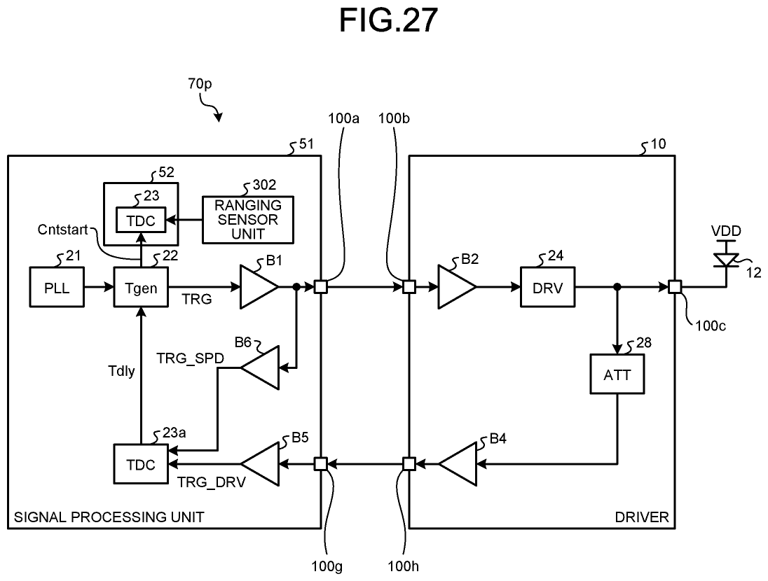

FIG. 27 is a diagram illustrating a ranging system 70p according to a second modification of the second embodiment described with reference to FIG. 22.

[2.5.1 Configuration]

In the ranging system 70m of the first modification of the second embodiment described with reference to FIG. 26, the path on the output side of the drive unit 24 in the driver 10 is bifurcated to return a signal to the signal processing unit 51. The ranging system 70p according to the second modification of the second embodiment illustrated in FIG. 27 includes an attenuator (ATT) 28 in a driver 10. The attenuator 28 is provided in a path after branching from the path on the output side of the drive unit 24. The attenuator 28 attenuates the signal level. Other configurations are the same as those of the ranging system 70k of the second embodiment, and thus description thereof will be omitted.

[2.5.2 Operation]

The attenuator 28 attenuates the signal level to a signal level that a buffer B4 can handle. The signal attenuated by the attenuator 28 is output to the signal processing unit 51 via the buffer B4. Other operations are the same as those of the ranging system 70k of the second embodiment, and thus description thereof will be omitted.

[2.5.3 Effects]

The attenuator 28 can attenuate to a signal level that the buffer B4 can handle.

(2.6 Third Modification of Second Embodiment)

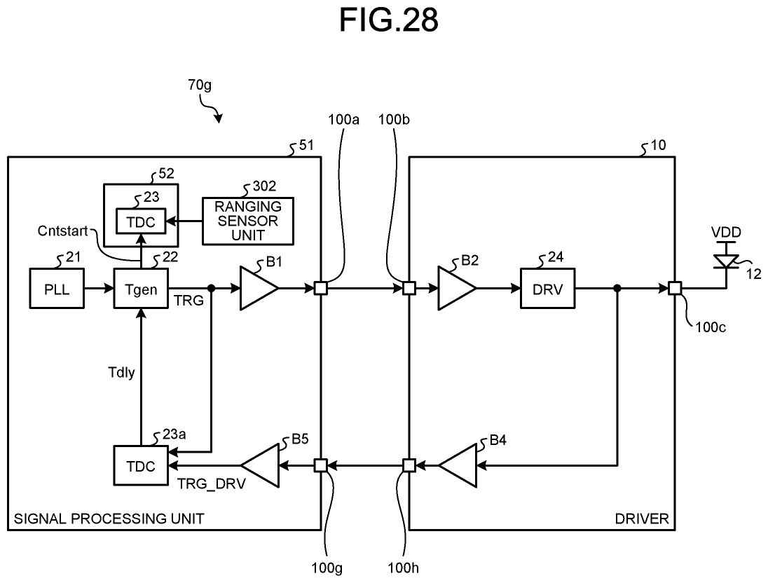

FIG. 28 is a diagram illustrating a ranging system 70q according to a third modification of the second embodiment described with reference to FIG. 22.

[2.6.1 Configuration]

In the ranging system 70k of the second embodiment described with reference to FIGS. 22 to 25, the path on the output side of the buffer B1 in the signal processing unit 51 is bifurcated. Meanwhile, as illustrated in FIG. 28, in the ranging system 70q according to the third modification of the second embodiment, a path on the input side of a buffer B1 in a signal processing unit 51 is bifurcated. That is, a trigger signal TRG is directly input to a TDC 23a. Other configurations are the same as those of the ranging system 70k of the second embodiment, and thus description thereof will be omitted.

[2.6.2 Operation]

The trigger signal TRG output from the light emission waveform generating circuit 22 is input to the TDC 23a without passing through the buffer B1. Therefore, the delay time due to the buffer B1 can be removed. Other operations are the same as those of the ranging system 70k of the second embodiment, and thus description thereof will be omitted.

[2.6.3 Effects]

Since the trigger signal TRG is directly input to the TDC 23a, the delay time due to the buffer B1 can be removed to measure the delay time.

(2.7 Fourth Modification of Second Embodiment)

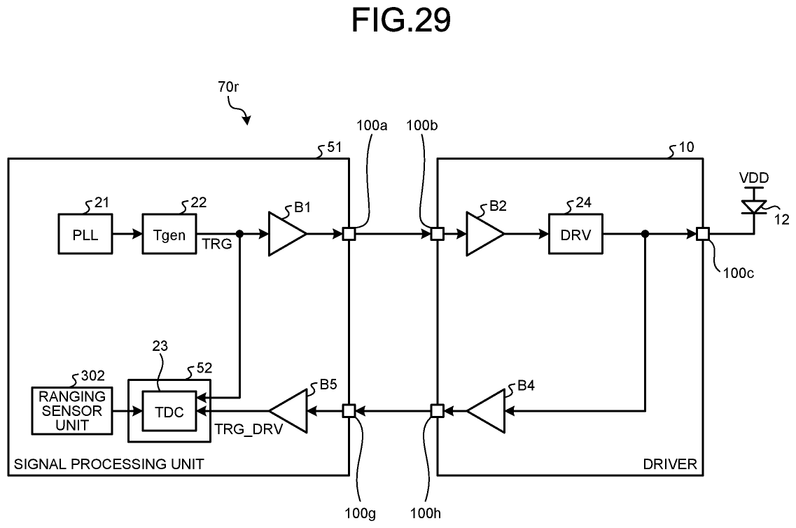

FIG. 29 is a diagram illustrating a ranging system 70r according to a fourth modification of the second embodiment described with reference to FIG. 22. As illustrated in FIG. 29, in the ranging system 70r according to the fourth modification of the second embodiment, a path on the input side of a buffer B1 in a signal processing unit 51 is bifurcated as in the ranging system 70q described with reference to FIG. 28. The ranging system 70r of the present example does not include a TDC 23a.

[2.7.1 Configuration]

As illustrated in FIG. 29, in the ranging system 70r according to the fourth modification of the second embodiment, a trigger signal TRG and an output signal of the buffer B5 are input to a TDC 23. Other configurations are the same as those of the ranging system 70k of the second embodiment, and thus description thereof will be omitted.

[2.7.2 Operation]

The TDC 23 starts counting time at the rise timing of the trigger signal TRG. The TDC 23 ends the counting time at the rise timing of the output signal of the buffer B5. The delay time can be measured by this counting time. In addition, the TDC 23 starts counting time at the rise timing of the trigger signal TRG and ends counting time at the timing when the ranging sensor unit 302 receives light. The delay time is subtracted from the time obtained from this counting time. As a result, it is possible to know not the output timing of the trigger signal TRG but timing that is closer to the actual light emitting timing, and thus it is possible to remove the delay time attributable to an internal circuit of the driver 10. Other operations are the same as those of the ranging system 70k of the second embodiment, and thus description thereof will be omitted.

[2.7.3 Effects]

In the ranging system 70r according to the fourth modification of the second embodiment, a subsequent stage of a drive unit 24, that is, a point close to a laser diode 12 is set as a measurement target. Therefore, the accuracy of ranging can be further improved.

(2.8 Fifth Modification of Second Embodiment)

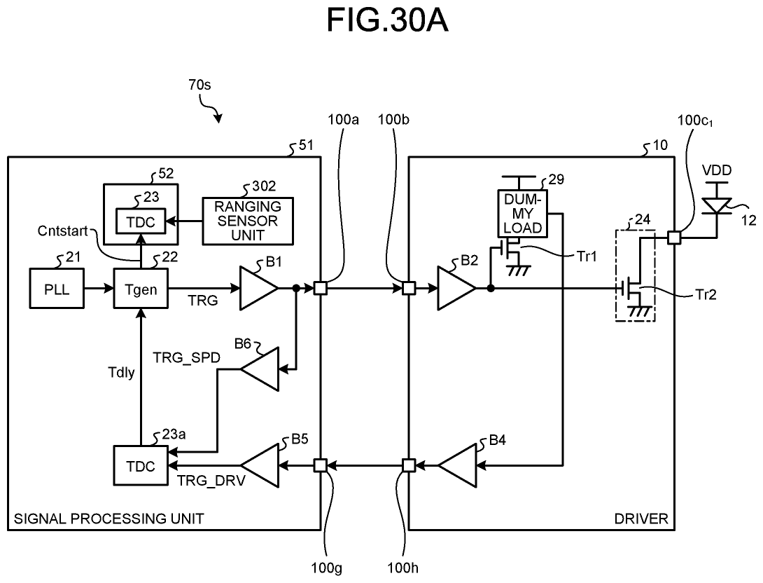

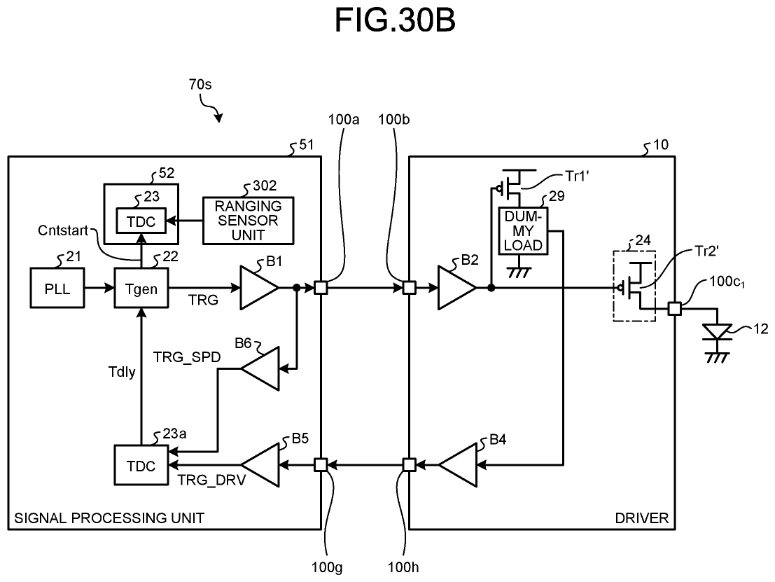

FIGS. 30A and 30B are diagrams illustrating a ranging system 70s according to a fifth modification of the second embodiment described with reference to FIG. 22. The ranging system 70q of the present example has a configuration in which a dummy load 29 is added inside the driver 10 of the ranging system 70k of the second embodiment described with reference to FIG. 22.

[2.8.1 Configuration]

As illustrated in FIG. 30A, the ranging system 70q of the present example includes the dummy load 29 provided in the driver 10. The dummy load 29 is connected to the output side of a buffer B2 via a transistor Tr1. The gate of the transistor Tr1 is connected to the output of the buffer B2.

A drive unit 24 includes a transistor Tr2. The gate of the transistor Tr2 is connected to the output of the buffer B2.

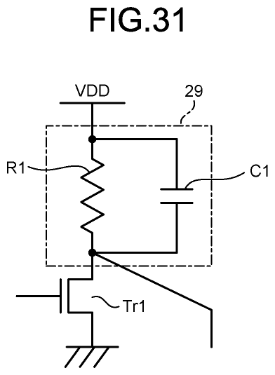

FIG. 31 is a diagram illustrating an example of the dummy load 29. As illustrated in FIG. 31, the dummy load 29 of this example includes a resistor R1 and a capacitor C1. The resistor R1 and the capacitor C1 are connected in parallel. The dummy load 29 has a time constant corresponding to the time required for a current to flow through a laser diode 12 to actually emit light. Other configurations are the same as those of the ranging system 70k of the second embodiment, and thus description thereof will be omitted.

Note that, as illustrated in FIG. 30B, the cathode of the laser diode 12 may be connected to the ground, and the anode may be connected to a transistor Tr2′ in the driver 10. The dummy load 29 is connected to a power supply via a transistor Tr′.

[2.8.2 Operation]

The transistor Tr2 in the drive unit 24 is turned on by an output signal of the buffer B2, and a current flows through the laser diode 12. As a result, the laser diode 12 emits light. In addition, the transistor Tr1 is turned on, and a signal having passed through the dummy load 29 is input to the buffer B4. As a result, a signal to the buffer B4 is output after elapse of a time corresponding to a time required for a current to flow through the laser diode 12 and to actually emit light. Other operations are the same as those of the ranging system 70k of the second embodiment, and thus description thereof will be omitted.

[2.8.3 Effects]

By disposing the dummy load 29, it becomes possible to return, to the signal processing unit 51, a signal in consideration of a delay time until a current flows through the laser diode 12 and the laser diode 12 emits light. As a result, the accuracy of ranging can be further improved.

(2.9 Sixth Modification of Second Embodiment)

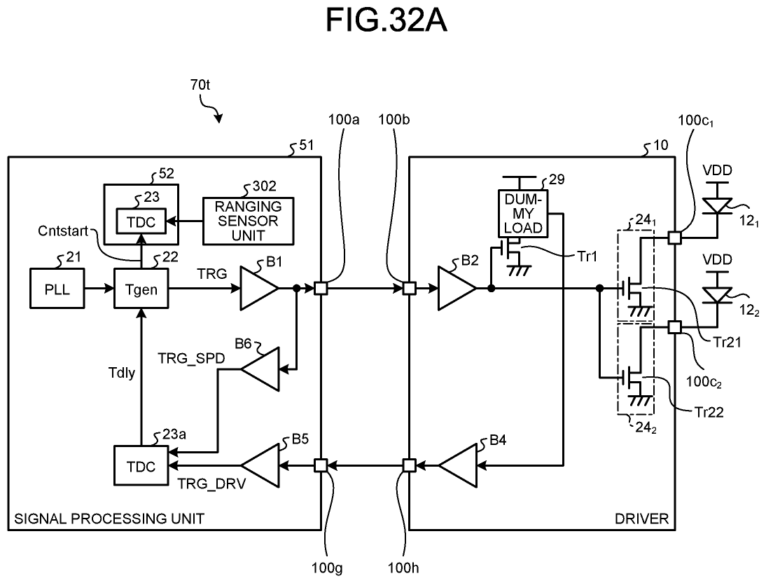

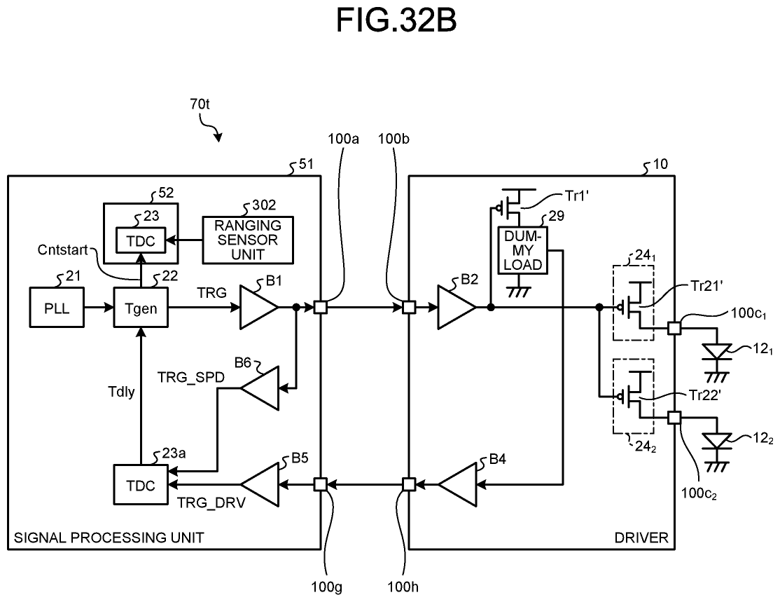

FIGS. 32A and 32B are diagrams illustrating a ranging system 70t according to a sixth modification of the second embodiment described with reference to FIG. 22. The ranging system 70s described with reference to FIGS. 30A, 30B, and 31 includes one laser diode 12. Meanwhile, the ranging system 70t of the present example illustrated in FIG. 32A includes a plurality of laser diodes.

[2.9.1 Configuration]

As illustrated in FIG. 32A, the ranging system 70t of the present example includes two laser diodes 12₁ and 12₂. The ranging system 70t of the present example includes drive units 24₁ and 24₂ corresponding to the laser diodes 12₁ and 12₂, respectively. The drive units 24₁ and 24₂ include transistors Tr21 and Tr22, respectively. The ranging system 70t may include N×M (N and M are natural numbers) laser diodes arrayed in a matrix shape. The above “N” and “M” may be the same value or different values. Other configurations are the same as those of the ranging system 70k of the second embodiment, and thus description thereof will be omitted.

Note that, as illustrated in FIG. 32B, the cathodes of the laser diodes 12₁ and 12₂ may be connected to the ground, and the anodes may be connected to transistors Tr21′ and Tr22′ in the driver 10. The dummy load 29 is connected to a power supply via a transistor Tr′.

[2.9.2 Operation]

The transistor Tr21 in the drive unit 24₁ and the transistor Tr22 in the drive unit 24₂ are turned on by an output signal of a buffer B2, and a current flows in the laser diodes 12₁ and 12₂. As a result, the laser diodes 12₁ and 12₂ emit light. In addition, the transistor Tr1 is turned on, and a signal to the buffer B4 is output after elapse of a time corresponding to a time required for a current to flow through the laser diode 12 and to actually emit light. Other operations are the same as those of the ranging system 70k of the second embodiment, and thus description thereof will be omitted.

[2.9.3 Effects]

According to the ranging system 70t of the present example, even in a case where a plurality of laser diodes is included, the delay time can be measured, and the accuracy of ranging can be improved.

Note that one output side of the plurality of drive units 24₁ and 24₂ may be bifurcated without providing the dummy load 29, and the output signal may be returned to the signal processing unit 51 side. Furthermore, instead of disposing the dummy load 29, a replica drive unit that simulates the drive unit 24 may be disposed, and an output signal of the replica drive unit may be returned to the signal processing unit 51 side.

(2.10 Seventh Modification of Second Embodiment)

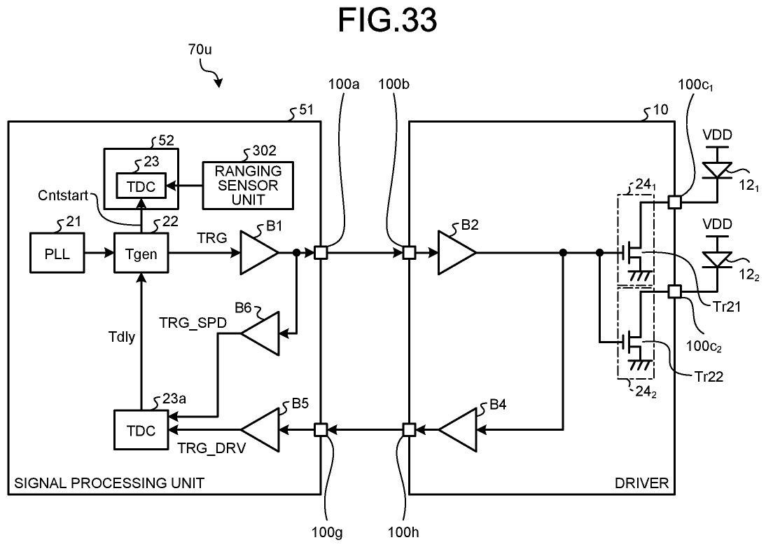

FIG. 33 is a diagram illustrating a ranging system 70u according to a seventh modification of the second embodiment described with reference to FIG. 22. As illustrated in FIG. 33, the ranging system 70u does not include a dummy load 29 that is provided in the ranging system 70t.

[2.10.1 Configuration]

As illustrated in FIG. 33, the ranging system 70u returns the output of the buffer B2, that is, a shared signal to a plurality of drive units 24₁ and 24₂ to a signal processing unit 51 side. Other configurations are the same as those of the ranging system 70k of the second embodiment, and thus description thereof will be omitted.

[2.10.2 Operation]

The transistor Tr21 in the drive unit 24₁ and the transistor Tr22 in the drive unit 24₂ are turned on by an output signal of a buffer B2, and a current flows in the laser diodes 12₁ and 12₂. As a result, the laser diodes 12₁ and 12₂ emit light. Other operations are the same as those of the ranging system 70k of the second embodiment, and thus description thereof will be omitted.

[2.10.3 Effects]

According to the ranging system 70u of the present example, even in a case where a plurality of laser diodes is included, the delay time can be measured, and the accuracy of ranging can be improved.

(2.11 Eighth Modification of Second Embodiment)

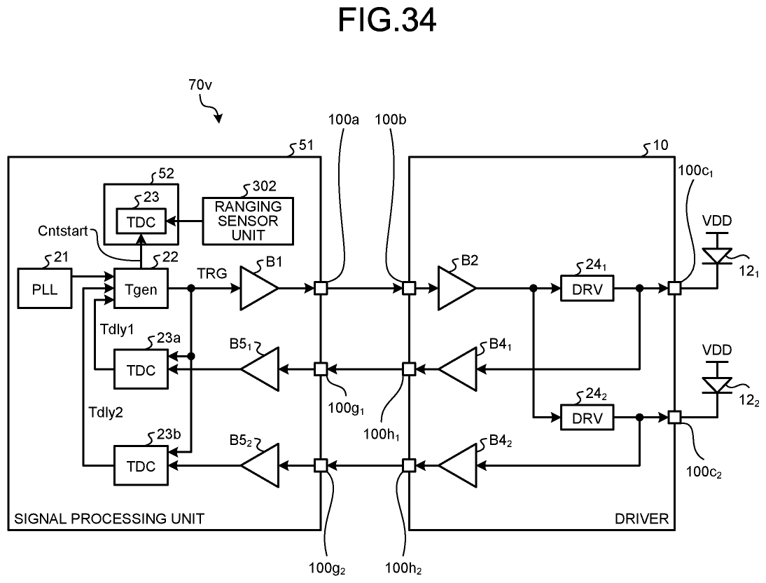

FIG. 34 is a diagram illustrating a ranging system 70v of an eighth modification of the second embodiment described with reference to FIG. 22. The ranging system 70v illustrated in FIG. 34 includes TDCs 23a and 23b as a plurality of measurement units corresponding to a plurality of drive units 24₁ and 24₂, respectively.

[2.11.1 Configuration]

As illustrated in FIG. 34, the ranging system 70v includes the TDC 23a corresponding to the drive unit 24₁ and the TDC 23b corresponding to the drive unit 24₂. A driver 10 includes a buffer B4₁ corresponding to the drive unit 24₁. The driver 10 includes a buffer B4₂ corresponding to the drive unit 24₂. The signal processing unit 51 includes a buffer B5₁ corresponding to the TDC 23a. The signal processing unit 51 includes a buffer B5₂ corresponding to the TDC 23b. The signal processing unit 51 and the driver 10 are coupled by coupling units 100a and 100b, coupling units 100g1 and 100h1, and coupling units 100g2 and 100h2. Other configurations are the same as those of the ranging system 70k of the second embodiment, and thus description thereof will be omitted.

[2.11.2 Operation]

In the ranging system 70v illustrated in FIG. 34, a drive signal of the drive unit 24₁ is output to a laser diode 12₁ via a coupling unit 100c1, branches on the output side of the drive unit 24₁, and is input to a TDC 23a of the signal processing unit 51 via the buffer B4₁ and the buffer B5₁. In addition, a drive signal of the drive unit 24₂ is output to the laser diode 12₂ via a coupling unit 100c2, branches on the output side of the drive unit ²⁴₂, and is input to the TDC 23b of the signal processing unit 51 via the buffer B4₂ and the buffer B5₂.

The TDCs 23a and 23b start counting time from the rise of a trigger signal TRG. The TDC 23a ends counting time at the rise timing of a drive signal of the drive unit 24₁ input via the buffer B4₁ and the buffer B5₁. The TDC 23b ends counting time at the rise timing of a drive signal of the drive unit 24₂ input via the buffer B4₂ and the buffer B5₂. The TDC 23a measures a delay time Tdly1. The TDC 23b measures a delay time Tdly2. Other operations are the same as those of the ranging system 70k of the second embodiment, and thus description thereof will be omitted.

[2.11.3 Effects]

According to the ranging system 70v of the present example, the delay time can be individually measured for each of the plurality of drive units, and the accuracy of ranging can be improved.

(2.12 Ninth Modification of Second Embodiment)

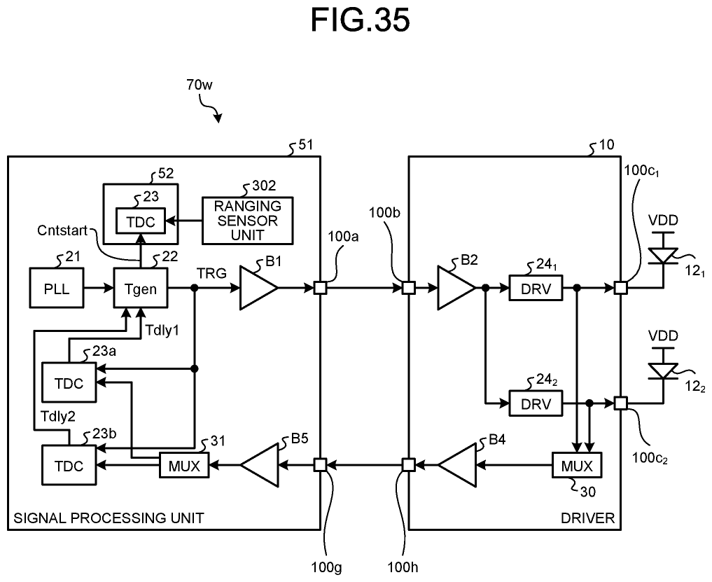

FIG. 35 is a diagram illustrating a ranging system 70w according to a ninth modification of the second embodiment described with reference to FIG. 22. The ranging system 70w illustrated in FIG. 35 is different from the ranging system 70v described with reference to FIG. 34 in that multiplexers (MUX) 30 and 31 are provided in a driver 10 and a signal processing unit 51, respectively.

[2.12.1 Configuration]

The driver 10 includes the multiplexer (MUX) 30, and the signal processing unit 51 includes the multiplexer (MUX) 31. The multiplexer 30 selects and inputs an output signal of a drive unit 24₁ and an output signal of a drive unit 24₂. The multiplexer 31 selects a TDC 23a or a TDC 23b. The multiplexer 31 inputs an output signal of a buffer B5 to one of the TDC 23a or the TDC 23b that is selected. The multiplexer 30 and the multiplexer 31 can be simultaneously switched.

[2.12.2 Operation]

In the ranging system 70w illustrated in FIG. 35, the multiplexer 30 selects and outputs the output signal of the drive unit 24₁ and the output signal of the drive unit 24₂. The output signal of the multiplexer 30 is input to the multiplexer 31 via buffers B4 and B5. The multiplexer 31 inputs the output signal of the multiplexer 30 to one of the TDC 23a or the TDC 23b that has been selected.

The TDCs 23a and 23b start counting time from the rise of a trigger signal TRG. The TDC 23a and the TDC 23b end counting time by an output signal of a multiplexer 31. Other operations are the same as those of the ranging system 70k of the second embodiment, and thus description thereof will be omitted.

[2.12.3 Effects]

According to the ranging system 70w of the present example, by using the multiplexer, it is possible to suppress an increase in the number of wires between the signal processing unit 51 and the driver 10 even in a case where the delay time is individually measured for a plurality of drive units.

(2.13 Tenth Modification of Second Embodiment)

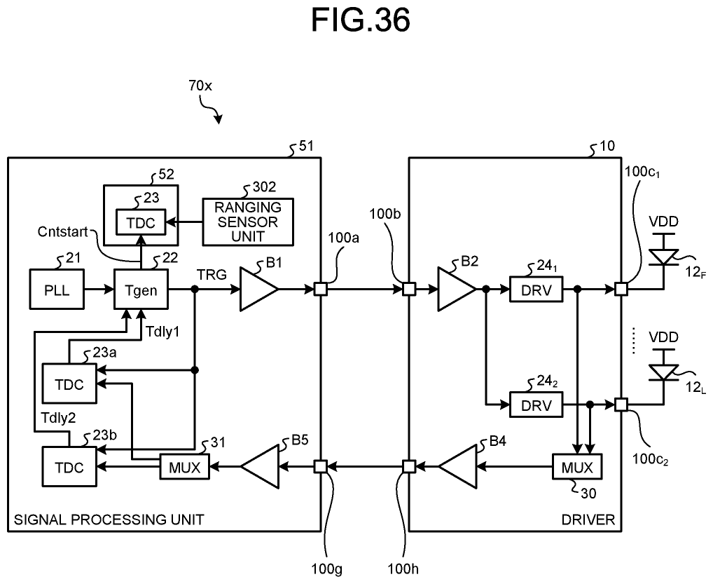

FIG. 36 is a diagram illustrating a ranging system 70xaccording to a tenth modification of the second embodiment described with reference to FIG. 22.

[2.13.1 Configuration]

In the ranging system 70x, the time estimated using the delay time measured for some laser diodes among a plurality of laser diodes is regarded as the delay time for other laser diodes.

The ranging system 70x includes a plurality of laser diodes and includes multiplexers 30 and 31 to perform switching as in the ranging system 70w described with reference to FIG. 35. There are cases where delay times as measurement results for the plurality of laser diodes do not have the same value. Here, among the plurality of laser diodes, a laser diode that has a short delay time and emits light fastest is referred to as a laser diode 12_{F}, and a laser diode that has a long delay time and emits light slowest is referred to as a laser diode 12_{L}.

An average value of the delay time measured for the laser diode 12_{F} and the delay time measured for the laser diode 12_{L} is obtained, and the delay time of the average value that has been obtained can be used for ranging using all the laser diodes.

In addition, a value obtained by performing linear interpolation on delay times measured for the laser diodes may be used for ranging. For example, a value, which is obtained by performing linear interpolation on delay times of laser diodes at several positions of two-dimensionally arrayed laser diodes, is used for ranging.

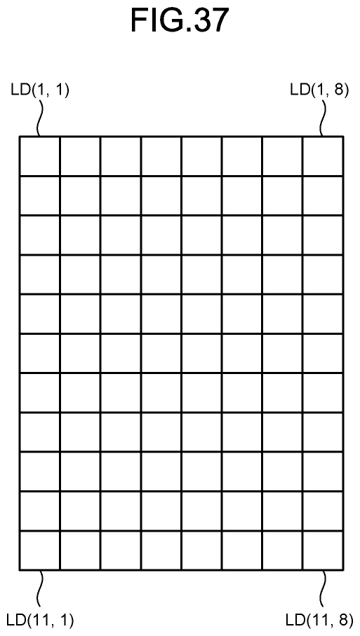

FIG. 37 is a diagram illustrating an example in which the plurality of laser diodes is two-dimensionally arrayed. The two-dimensionally arrayed laser diodes (hereinafter, an LD array) are, for example, vertical cavity surface emitting lasers (VCSELs). In FIG. 37, in the present example, laser diodes are arranged at respective positions of eleven rows×eight columns. Here, in FIG. 37, the laser diode at the upper left position is denoted by LD (1, 1), the laser diode at the upper right position is denoted by LD (1, 8), the laser diode at the lower left position is denoted by LD (11, 1), and the laser diode at the lower right position is denoted by LD (1, 8).

[2.13.2 Operation]

If the delay time of the LD (1, 1) is the shortest and the delay time of the LD (11, 8) is the longest, the LD (1, 1) and the LD (11, 1) are set as measurement targets. The delay time of the other laser diodes can be estimated by performing linear interpolation between the delay time of the LD (1, 1) and the delay time of the LD (11, 1). If the wiring length from the light emission waveform generating circuit 22 is known, the estimation can be made by performing weighting depending on the length.

[2.13.3 Effects]

According to the ranging system 70x of the tenth modification of the second embodiment, by performing linear interpolation or the like, it is possible to improve the accuracy of ranging without setting all the laser diodes included in the LD array as measurement targets.

(2.14 Eleventh Modification of Second Embodiment)

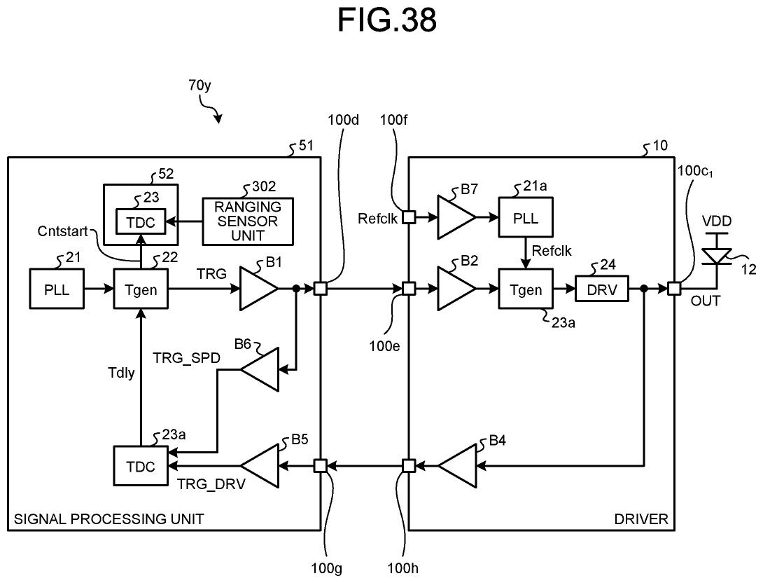

FIG. 38 is a diagram illustrating a ranging system 70y according to an eleventh modification of the second embodiment described with reference to FIG. 22. The ranging system 70y illustrated in FIG. 38 has a configuration in which a buffer B7, a PLL unit 21a, and a light emission waveform generating circuit 22a are added to the ranging system 70k described with reference to FIG. 22.

[2.14.1 Configuration]

The buffer B7 includes two CMOS inverters connected in cascade like other buffers. The PLL unit 21a receives a clock signal Refclk as the input. The light emission waveform generating circuit 22a operates a drive unit 24. Other configurations are similar to those of the ranging system 70k described with reference to FIG. 22, and thus description thereof will be omitted.

[2.14.2 Operation]

The PLL unit 21a receives a clock signal Refclk as input and outputs a clock signal Refclk′ having a phase matching the phase of the clock signal Refclk. When a trigger signal TRG is input from a signal processing unit 51, the light emission waveform generating circuit 22a operates the drive unit 24. The drive unit 24 outputs an output signal OUT. Furthermore, the path of the output signal OUT output from the drive unit 24 branches, and the output signal OUT is sent to the signal processing unit 51 via a buffer B4.

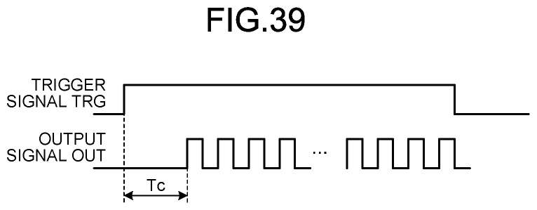

FIG. 39 is a diagram for explaining the operation of the light emission waveform generating circuit 22a. FIG. 39 is a diagram illustrating the trigger signal TRG and the output signal OUT. The light emission waveform generating circuit 22a of the present example outputs the output signal OUT that changes similarly to the clock signal Refclk′ after a predetermined period of time Tc elapses from the rise of the trigger signal TRG. The light emission waveform generating circuit 22a outputs the output signal OUT only while the trigger signal TRG is at a high level. Note that the light emission waveform generating circuit 22a can output the output signal OUT of various waveform patterns without being limited to the output signal OUT that changes as illustrated in FIG. 39. Other operations are the same as those of the ranging system 70k of the second embodiment, and thus description thereof will be omitted.

[2.14.3 Effects]

A signal in consideration of the delay time by the light emission waveform generating circuit 22a can be returned to the signal processing unit 51. As a result, the accuracy of ranging can be further improved.

### 3.1 Third Embodiment

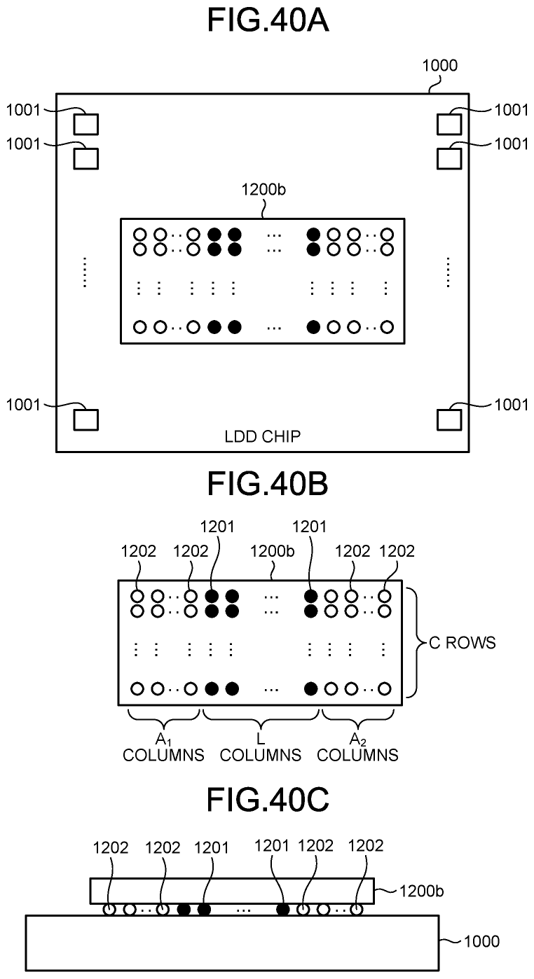

FIGS. 40A to 40C are diagrams illustrating a ranging system according to a third embodiment. The third embodiment relates to implementation of the laser diodes and the drivers of the ranging systems according to the first embodiment and the second embodiment described above. In the third embodiment, arranged laser diodes (hereinafter, an LD array) and other components included in a driver are formed on another substrate.

FIG. 40A is a diagram schematically illustrating a state in which an LD array 1200b is arranged on a laser diode driver (LDD) chip 1000 on which each element included in a driver is arranged, which is applicable to the third embodiment. FIG. 40A is a diagram illustrating the LDD chip 1000 and the LD array 1200b when viewed from a side (top side) on which light emitting units of respective laser diodes 12 included in the LD array 1200b are arranged. Note that, in FIG. 40A and FIG. 40B to be described later, the LD array 1200b is illustrated in a state where the side (back side) coupled with the LDD chip 1000 is seen through from the top side where the light emitting units of the laser diodes 12 are arranged.

The LDD chip 1000 is a semiconductor chip and is coupled with an external circuit by wire bonding to a plurality of pads 1001 arranged in a peripheral portion. For example, a power supply voltage V_{DD} is supplied to the LDD chip 1000 externally via a pad 1001.

FIG. 40B is a diagram schematically illustrating a configuration of the LD array 1200b applicable to the third embodiment. As illustrated in FIG. 40B, on the back side of the LD array 1200b, respective cathode terminals 1201 of the plurality of laser diodes 12 included in the LD array 1200b and anode terminals 1202 shared by the plurality of laser diodes 12 are aligned and arranged.

In the example of FIG. 40B, regarding the horizontal direction in the drawing as a row and the vertical direction as a column, the cathode terminals 1201 are arranged at the center of the LD array 1200b in a lattice-shaped array of C rows×L columns. That is, in this example, (C×L) laser diodes 12 are arranged in the LD array 1200b. Meanwhile, the anode terminals 1202 are arranged in a lattice arrangement of C rows×A₁ columns on the left end side of the LD array 1200b and C rows×A₂ columns on the right end side.

FIG. 40C is a side view of the structure including the LDD chip 1000 and the LD array 1200b, which is applicable to the third embodiment, as viewed from the lower end side of FIG. 40A. As described above, the LDD chip 1000 and the LD array 1200b have a structure in which the LD array 1200b is stacked on the LDD chip 1000. Each cathode terminal 1201 and each anode terminal 1202 are connected to the LDD chip 1000 by, for example, micro-bump.

### 4.1 Fourth Embodiment

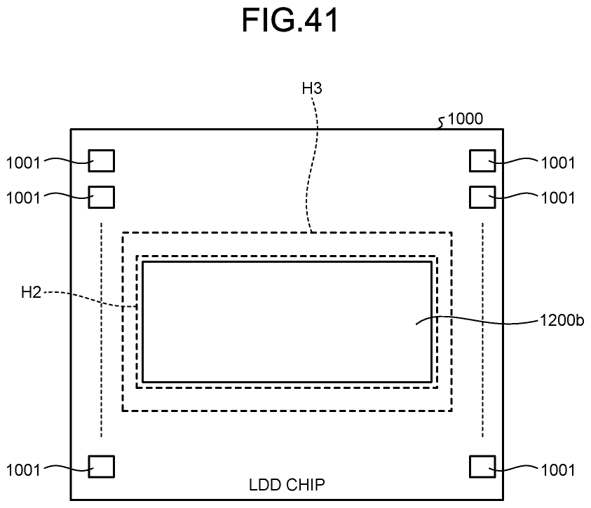

FIG. 41 is a diagram illustrating a ranging system according to a fourth embodiment. FIG. 41 is a diagram illustrating an embodiment related to the layout of each unit in an LDD chip.

An LD array 1200b is disposed, for example, in the area of a broken line H2. In that case, it is preferable that each drive unit 24 of the driver 10 be arranged immediately below the LD array 1200b. With this arrangement, it is possible to bring the positions of laser diodes included in the LD array 1200b and the positions of the drive units corresponding thereto close to each other. As a result, it is possible to obtain an effect of facilitating wiring between the laser diode and the drive unit.

It is preferable that the TDC 23 provided in the driver 10 in the first embodiment be arranged in the vicinity of the LD array 1200b. It is preferable that the TDC 23 be disposed, for example, in the area indicated by a broken line H3. As a result, it is possible to obtain an effect of facilitating the wiring for extracting an output signal OUT output from the drive unit 24 and inputting the output signal OUT to the TDC 23.

Note that it is preferable that the temperature sensor 26 provided in the ranging system 70f illustrated in FIG. 17 be disposed in the vicinity of the LD array. For example, a temperature sensor 26 is preferably disposed in the area indicated by the broken line H3. Since the laser diodes generate a large amount of heat, the amount of heat generation can be efficiently detected by disposing a temperature sensor near the laser diodes.

### 5. Summary

A ranging system includes a drive unit 24, a ranging sensor unit 302 that is a sensor unit, a TDC 23a that is a measurement unit, and a ranging observation unit 52 that is a processing unit. The drive unit 24 outputs a drive signal for causing the laser diode 12, which is a light emitting element, to emit light to irradiate a target 61 with the light. The ranging sensor unit 302 detects reflected light from the target 61. The TDC 23a measures a delay time that is a time included in the time from the timing at which a trigger signal for causing the light emitting element to emit light is output to the timing at which the light emitting element actually emits light. The ranging observation unit 52 calculates a distance to a target 61 on the basis of the output timing of the trigger signal, light receiving timing of the reflected light obtained by the ranging sensor unit 302, and the delay time.

As a result, ranging can be performed using the delay time having been measured, and the accuracy of ranging can be further improved.

The TDC 23a as the measurement unit starts counting time from the rise timing of the trigger signal, ends counting time at the output timing of a drive signal to the laser diode 12 as the light emitting element, and uses the time count value as the delay time.

As a result, it is possible to measure the delay time which is a time included in the time until the timing at which the laser diode 12, as the light emitting element, actually emits light.

The ranging system may include a light emission waveform generating circuit 22a which is a light emission waveform generating unit. The light emission waveform generating circuit 22a generates a light emission pattern signal for causing the light emitting element to emit light.

As a result, the delay time can be measured using the light emission pattern signal generated by the light emission waveform generating circuit 22a.

The ranging system may include a replica drive unit 24R imitating the drive unit 24. The TDC 23a, as the measurement unit, ends counting time at the output timing of a signal of the replica drive unit 24R.

As a result, the accuracy of ranging can be improved using the replica drive unit 24R.

The ranging system may include a buffer BV which is a delay amount adjusting unit. The delay time of the signal passing through the replica drive unit 24R can be adjusted by the buffer BV that is the delay amount adjusting unit.

As a result, even in a case where the replica drive unit 24R is used, the accuracy of ranging can be improved.

The ranging system may include a temperature sensor 26 that detects a temperature. The delay amount of the buffer BV, which is the delay amount adjusting unit, is adjusted on the basis of the temperature detected by the temperature sensor 26.

As a result, the accuracy of ranging can be enhanced even in a case where the temperature changes.

The TDC 23a, which is the measurement unit, may start counting time from the rise timing of the trigger signal, end counting time at the output timing of a signal on the input side of the drive unit 24, and set the time count value as the delay time.

As a result, even in a case where the output signal of the drive unit 24 cannot be used, it is possible to measure the delay time.

The ranging system may include a plurality of drive units corresponding to a plurality of light emitting elements. The TDC 23a, which is the measurement unit, starts counting time from the rise timing of the trigger signal, ends counting time at the output timing of one drive signal of the plurality of drive units, and sets the time count value as the delay time.

As a result, it is possible to measure the delay time using one drive signal of the plurality of drive units corresponding to the plurality of light emitting elements and use the delay time that has been measured when ranging using another light emitting element is performed.

The ranging system may include a selector 27 that selects one of drive signals output from the plurality of drive units. The TDC 23a as the measurement unit ends counting time at the output timing of the drive signal selected by the selector 27 and sets the time count value as the delay time.

As a result, in a case where the delay time is measured using respective drive signals of the plurality of drive units, it is possible to prevent the wiring from becoming complicated.

The ranging system may include a plurality of TDCs 23a and 23b corresponding to a plurality of drive units 24.

As a result, for example, the ranging can be performed using an average value of delay times measured by the two TDCs 23a and 23b, and the ranging accuracy can be further improved.

The ranging system may include a storage unit 25M that stores data corresponding to the delay time. The ranging observation unit 52, which is the processing unit, performs a process of calculating the distance to the target using the data stored in the storage unit 25M.

As a result, ranging can be performed using the data stored in the storage unit 25M.

The ranging system may include a signal processing unit 51 including the ranging observation unit 52 as the processing unit and a driver 10 including the drive unit 24, and a storage unit 25M may be provided in at least one of the driver 10 or the signal processing unit 51.

As a result, ranging can be performed using the data stored in the storage unit 25M.

The ranging observation unit 52, which is the processing unit, may start counting time after a time corresponding to the delay time from the output timing of the trigger signal TRG, end counting time at the light receiving timing of the reflected light, and calculate the distance to the target 61 on the basis of the time count result.

As a result, ranging can be performed by adjusting the start timing of counting time.

The ranging system may include a signal processing unit 51 including the ranging observation unit 52 as the processing unit and a driver 10 including the drive unit 24, and the TDC 23a as the measurement unit may be provided in the signal processing unit 51. The TDC 23a bifurcates the transmission path of the trigger signal in the signal processing unit 51, starts counting time from the rise timing of a signal obtained by returning the trigger signal, bifurcates the transmission path of the trigger signal on the input side of the drive unit 24, ends counting time at the rise timing of the signal obtained by returning the trigger signal, and sets the time count value as the delay time.

As a result, the delay time can be measured in the signal processing unit 51.

The ranging system may include a signal processing unit 51 including the ranging observation unit 52 as the processing unit and a driver 10 including the drive unit 24, and the TDC 23a as the measurement unit may be provided in the signal processing unit 51. The TDC 23a bifurcates the transmission path of the trigger signal in the signal processing unit 51, starts counting time from the rise timing of a signal obtained by returning the trigger signal, bifurcates the transmission path of the trigger signal on the output side of the drive unit, ends counting time at the rise timing of the signal obtained by returning the trigger signal, and sets the time count value as the delay time.

As a result, the delay time can be measured in the signal processing unit 51.

The ranging system may include an attenuator 28 that bifurcates on the output side of the drive unit 24 and attenuates the signal level of a signal obtained by returning the trigger signal. A buffer B4 that receives the signal attenuated by the attenuator 28 as input and outputs the signal to the signal processing unit 51 may be included.

As a result, the attenuator 28 can attenuate the signal level to a signal level that the buffer B4 can handle.

The ranging system may include a dummy load 29 that receives, as the input, a signal branched from the transmission path of the trigger signal on the input side of the drive unit 24. The dummy load 29 has a time constant corresponding to the time required for a current to flow through the light emitting element to actually emit light and may output a signal, which has passed through the dummy load 29, to the signal processing unit 51 from the driver 10 as a signal obtained by returning the trigger signal.

By disposing the dummy load 29, it becomes possible to return, to the signal processing unit 51, a signal in consideration of a delay time until a current flows through the laser diode 12 and the laser diode 12 emits light. As a result, the accuracy of ranging can be further improved.

A plurality of drive units corresponding to a plurality of light emitting elements and a plurality of TDCs 23a and 23b provided corresponding to the plurality of drive units may be included. Each of the plurality of TDCs 23a and 23b bifurcates the transmission path of the trigger signal on one of the output sides of the plurality of drive units, ends counting time at the rise timing of the signal obtained by returning the trigger signal, and sets the time count value as the delay time.

As a result, even in a case where a plurality of drive units corresponding to a plurality of light emitting elements is included, the accuracy of ranging can be improved.

The ranging system may include a first multiplexer 30 and a second multiplexer 31. The first multiplexer 30 selects and outputs a signal output from the plurality of drive units. The second multiplexer 31 inputs the output of the first multiplexer 30 to a selected one of the plurality of TDCs 23a and 23b.

As a result, even in a case where a plurality of drive units corresponding to a plurality of light emitting elements is included, the accuracy of ranging can be improved.

In a case where the ranging system includes a plurality of light emitting elements, the delay time for light emitting elements disposed in the middle may be obtained by interpolation of two delay times.

As a result, even when the delay time is not measured for all of the plurality of light emitting elements, the accuracy of ranging can be further improved using the delay time obtained by interpolation.

A driver of a light emitting element includes a drive unit 24 and a TDC 23a as the measurement unit. The drive unit 24 outputs a drive signal for causing the light emitting element to emit light to irradiate the target with light. The TDC 23a measures a delay time that is a time included in the time from the timing at which a trigger signal for causing the light emitting element to emit light is input to the timing at which the light emitting element actually emits light. Data corresponding to the delay time measured by the TDC 23a is output and stored in the storage unit 25M, for example.

As a result, ranging can be performed using the data corresponding to the delay time, and the accuracy of ranging can be further improved.

Note that the effects described herein are merely examples and are not limiting, and other effects may also be achieved. In addition, the configurations described herein can be combined as appropriate.

Note that the present technology can also have the following configurations.

(1)

A ranging system comprising:

a drive unit that causes a light emitting element to emit light and outputs a drive signal for irradiating a target with light;

a sensor unit that detects reflected light from the target;

a measurement unit that measures a delay time that is included in a time from timing at which a trigger signal for causing the light emitting element to emit light is output to timing at which the light emitting element actually emits light; and

a processing unit that performs a process of calculating a distance to the target on a basis of output timing of the trigger signal, light receiving timing of the reflected light obtained by the sensor unit, and the delay time.

(2)

The ranging system according to (1),

wherein the measurement unit starts counting time from rise timing of the trigger signal, ends counting time at output timing of the drive signal to the light emitting element, and sets the time count value as the delay time.

(3)

The ranging system according to (1) or (2), further comprising a light emission waveform generating unit that generates a light emission pattern signal for causing the light emitting element to emit light.

(4)

The ranging system according to (2), further comprising

a replica drive unit that simulates the drive unit,

wherein the measurement unit ends counting time at output timing of a signal by the replica drive unit.

(5)

The ranging system according to (4), further comprising a delay amount adjusting unit that adjusts a delay time of the signal passing through the replica drive unit.

(6)

The ranging system according to (5), further comprising a temperature sensor that detects a temperature, wherein a delay amount of the delay amount adjusting unit is adjusted on a basis of the temperature detected by the temperature sensor.

(7)

The ranging system according to (2),

wherein the measurement unit starts counting time from the rise timing of the trigger signal, ends counting time at output timing of a signal on an input side of the drive unit, and sets the time count value as the delay time.

(8)

The ranging system according to (2), further comprising a plurality of the drive units corresponding to a plurality of the light emitting elements,

wherein the measurement unit starts counting time from the rise timing of the trigger signal, ends counting time at output timing of one of the drive signals of the plurality of the drive units, and sets the time count value as the delay time.

(9)

The ranging system according to (2), further comprising a selector that selects one of the drive signals output from a plurality of the drive units,

wherein the measurement unit ends counting time at output timing of the drive signal selected by the selector and sets the time count value as the delay time.

(10)

The ranging system according to (2), further comprising a plurality of the measurement units corresponding to a plurality of the drive units.

(11)

The ranging system according to any one of (1) to (10), further comprising

a storage unit that stores data corresponding to the delay time,

wherein the processing unit performs the process of calculating the distance to the target using the data stored in the storage unit.

(12)

The ranging system according to (11), further comprising a signal processing unit including the processing unit; and a driver including the drive unit,

wherein the storage unit is provided in at least one of the driver and the signal processing unit.

(13)

The ranging system according to any one of (1) to (12),

wherein the processing unit starts counting time after a time corresponding to the delay time from the output timing of the trigger signal, ends counting time at the light receiving timing of the reflected light, and calculates the distance to the target on a basis of the time count result.

(14)

The ranging system according to (2), further comprising: a signal processing unit including the processing unit; and a driver including the drive unit,

wherein the measurement unit is provided in the signal processing unit, and

the measurement unit bifurcates a transmission path of the trigger signal in the signal processing unit, starts counting time from rise timing of a signal obtained by returning the trigger signal, bifurcates the transmission path of the trigger signal on an input side of the drive unit, ends counting time at rise timing of a signal obtained by returning the trigger signal, and sets the time count value as the delay time.

(15)

The ranging system according to (2), further comprising: a signal processing unit including the processing unit; and a driver including the drive unit,

wherein the measurement unit is provided in the signal processing unit, and

the measurement unit bifurcates a transmission path of the trigger signal in the signal processing unit, starts counting time from rise timing of a signal obtained by returning the trigger signal, bifurcates the transmission path of the trigger signal on an output side of the drive unit, ends counting time at rise timing of a signal obtained by returning the trigger signal, and sets the time count value as the delay time.

(16)

The ranging system according to (15), further comprising:

an attenuator that bifurcates on the output side of the drive unit and attenuates a signal level of a signal obtained by returning the trigger signal; and

a buffer that receives a signal attenuated by the attenuator as input and outputs the signal to the signal processing unit.

(17)

The ranging system according to (14), further comprising

a dummy load that receives, as input, a signal branched from the transmission path of the trigger signal on the input side of the drive unit,

wherein the dummy load has a time constant corresponding to a time required for a current to flow through the light emitting element to actually emit light, and

a signal which has passed through the dummy load is output from the driver to the signal processing unit as a signal obtained by returning the trigger signal.

(18)

The ranging system according to (2), further comprising: a plurality of the drive units corresponding to a plurality of the light emitting elements; and a plurality of the measurement units provided in correspondence to the plurality of the drive units,

wherein each of the plurality of measurement units bifurcates the transmission path of the trigger signal on a respective output sides of the plurality of drive units, ends counting time at rise timing of a signal obtained by returning the trigger signal, and sets the time count value as the delay time.

(19)

The ranging system according to (18), further comprising: a first multiplexer that selects and outputs one of output signals of the plurality of drive units; and a second multiplexer that inputs the output of the first multiplexer to a selected one of the plurality of the measurement units.

(20)

The ranging system according to (18) or (19),

wherein the plurality of the light emitting elements includes a first light emitting element and a second light emitting element, and

the delay time for a light emitting element provided between the first light emitting element and the second light emitting element is obtained by interpolation between the delay time of the first light emitting element and the delay time of the second light emitting element.

(21)

A driver of a light emitting element, comprising:

a drive unit that causes the light emitting element to emit light and outputs a drive signal for irradiating a target with light; and

a measurement unit that measures a delay time that is included in a time from timing at which a trigger signal for causing the light emitting element to emit light is input to timing at which the light emitting element actually emits light,

wherein the driver outputs data corresponding to the delay time measured by the measurement unit.

(22)

The driver of the light emitting element according to (21), further including a storage unit that stores data corresponding to the delay time measured by the measurement unit, in which the driver outputs the data stored in the storage unit.

### REFERENCE SIGNS LIST

10 DRIVER

11 CONTROLLER

12 LASER DIODE

21, 21a PLL UNIT

22, 22a LIGHT EMISSION WAVEFORM GENERATING CIRCUIT

23, 23a, 23a₁, 23b₁ TDC

24 DRIVE UNIT

24R REPLICA DRIVE UNIT

25 LOGIC UNIT

25M STORAGE UNIT

26 TEMPERATURE SENSOR

27 SELECTOR

28 ATTENUATOR

29 DUMMY LOAD

30, 31 MULTIPLEXER

51 SIGNAL PROCESSING UNIT

52 RANGING OBSERVATION UNIT

53 PROCESSING UNIT

61 TARGET

70, 70a to 70k, 70m, 70p to 70y RANGING SYSTEM

12, 12₁ to 12_{N} LASER DIODE

24, 24₁ to 24_{N} DRIVE UNIT

302 RANGING SENSOR UNIT

1. A ranging system comprising:
a drive unit that causes a light emitting element to emit light and outputs a drive signal for irradiating a target with light;
a sensor unit that detects reflected light from the target;
a measurement unit that measures a delay time that is included in a time from timing at which a trigger signal for causing the light emitting element to emit light is output to timing at which the light emitting element actually emits light; and
a processing unit that performs a process of calculating a distance to the target on a basis of output timing of the trigger signal, light receiving timing of the reflected light obtained by the sensor unit, and the delay time.

2. The ranging system according to claim 1,
wherein the measurement unit starts counting time from rise timing of the trigger signal, ends counting time at output timing of the drive signal to the light emitting element, and sets the time count value as the delay time.

3. The ranging system according to claim 1, further comprising a light emission waveform generating unit that generates a light emission pattern signal for causing the light emitting element to emit light.

4. The ranging system according to claim 2, further comprising
a replica drive unit that simulates the drive unit,
wherein the measurement unit ends counting time at output timing of a signal by the replica drive unit.

5. The ranging system according to claim 4, further comprising a delay amount adjusting unit that adjusts a delay time of the signal passing through the replica drive unit.

6. The ranging system according to claim 5, further comprising a temperature sensor that detects a temperature, wherein a delay amount of the delay amount adjusting unit is adjusted on a basis of the temperature detected by the temperature sensor.

7. The ranging system according to claim 2,
wherein the measurement unit starts counting time from the rise timing of the trigger signal, ends counting time at output timing of a signal on an input side of the drive unit, and sets the time count value as the delay time.

8. The ranging system according to claim 2, further comprising a plurality of the drive units corresponding to a plurality of the light emitting elements,
wherein the measurement unit starts counting time from the rise timing of the trigger signal, ends counting time at output timing of one of the drive signals of the plurality of the drive units, and sets the time count value as the delay time.

9. The ranging system according to claim 2, further comprising a selector that selects one of the drive signals output from a plurality of the drive units,
wherein the measurement unit ends counting time at output timing of the drive signal selected by the selector and sets the time count value as the delay time.

10. The ranging system according to claim 2, further comprising a plurality of the measurement units corresponding to a plurality of the drive units.

11. The ranging system according to claim 1, further comprising
a storage unit that stores data corresponding to the delay time,
wherein the processing unit performs the process of calculating the distance to the target using the data stored in the storage unit.

12. The ranging system according to claim 11, further comprising a signal processing unit including the processing unit; and a driver including the drive unit,
wherein the storage unit is provided in at least one of the driver and the signal processing unit.

13. The ranging system according to claim 1,
wherein the processing unit starts counting time after a time corresponding to the delay time from the output timing of the trigger signal, ends counting time at the light receiving timing of the reflected light, and calculates the distance to the target on a basis of the time count result.

14. The ranging system according to claim 2, further comprising: a signal processing unit including the processing unit; and a driver including the drive unit,
wherein the measurement unit is provided in the signal processing unit, and
the measurement unit bifurcates a transmission path of the trigger signal in the signal processing unit, starts counting time from rise timing of a signal obtained by returning the trigger signal, bifurcates the transmission path of the trigger signal on an input side of the drive unit, ends counting time at rise timing of a signal obtained by returning the trigger signal, and sets the time count value as the delay time.

15. The ranging system according to claim 2, further comprising: a signal processing unit including the processing unit; and a driver including the drive unit,
wherein the measurement unit is provided in the signal processing unit, and
the measurement unit bifurcates a transmission path of the trigger signal in the signal processing unit, starts counting time from rise timing of a signal obtained by returning the trigger signal, bifurcates the transmission path of the trigger signal on an output side of the drive unit, ends counting time at rise timing of a signal obtained by returning the trigger signal, and sets the time count value as the delay time.

16. The ranging system according to claim 15, further comprising:
an attenuator that bifurcates on the output side of the drive unit and attenuates a signal level of a signal obtained by returning the trigger signal; and
a buffer that receives a signal attenuated by the attenuator as input and outputs the signal to the signal processing unit.

17. The ranging system according to claim 14, further comprising
a dummy load that receives, as input, a signal branched from the transmission path of the trigger signal on the input side of the drive unit,
wherein the dummy load has a time constant corresponding to a time required for a current to flow through the light emitting element to actually emit light, and
a signal which has passed through the dummy load is output from the driver to the signal processing unit as a signal obtained by returning the trigger signal.

18. The ranging system according to claim 2, further comprising: a plurality of the drive units corresponding to a plurality of the light emitting elements; and a plurality of the measurement units provided in correspondence to the plurality of the drive units,
wherein each of the plurality of measurement units bifurcates the transmission path of the trigger signal on a respective output sides of the plurality of drive units, ends counting time at rise timing of a signal obtained by returning the trigger signal, and sets the time count value as the delay time.

19. The ranging system according to claim 18, further comprising: a first multiplexer that selects and outputs one of output signals of the plurality of drive units; and a second multiplexer that inputs the output of the first multiplexer to a selected one of the plurality of the measurement units.

20. The ranging system according to claim 18,
wherein the plurality of the light emitting elements includes a first light emitting element and a second light emitting element, and
the delay time for a light emitting element provided between the first light emitting element and the second light emitting element is obtained by interpolation between the delay time of the first light emitting element and the delay time of the second light emitting element.

21. A driver of a light emitting element, comprising:
a drive unit that causes the light emitting element to emit light and outputs a drive signal for irradiating a target with light; and
a measurement unit that measures a delay time that is included in a time from timing at which a trigger signal for causing the light emitting element to emit light is input to timing at which the light emitting element actually emits light,
wherein the driver outputs data corresponding to the delay time measured by the measurement unit.
